(19) United States
(12) Patent Application Publication
(10) Pub. No.: US 2015/0381433 A1
(43) Pub. Date: Dec. 31, 2015

(54) MANAGEMENT SUPPORT METHOD, MANAGEMENT SUPPORT DEVICE, AND MANAGEMENT SUPPORT PROGRAM

(71) Applicant: FUJITSU LIMITED, Kawasaki-shi (JP)

(72) Inventors: Kengo KIMURA, Yokohama (JP); Takeshi GOMI, Kawasaki (JP)

(21) Appl. No.: 14/744,148

(22) Filed: Jun. 19, 2015

(30) Foreign Application Priority Data
Jun. 27, 2014 (JP) 2014-132474

(51) Int. Cl. H04L 12/24; G06F 9/455

(52) U.S. Cl. CPC H04L 41/20; G06F 9/45504

(57) ABSTRACT

A management support method includes causing a first reference server to run a first application that is installed in each of a plurality of managed servers, causing a second reference to run a second application that is in an exclusive relation with the first application when the second application is present in any one of the plurality of managed servers, presenting a judgement result whether the second reference server is to be operated continuously by comparing an operating state of the first application on the first reference server and an operating state of the second application on the second reference server, and selecting whether the first application or the second application is to be operated in the first reference server when the judgement result is that the second reference server is not to be operated continuously.

### CROSS-REFERENCE TO RELATED APPLICATION

This application is based upon and claims the benefit of priority of the prior Japanese Patent Application No. 2014-132474, filed on Jun. 27, 2014, the entire contents of which are incorporated herein by reference.

### FIELD

The present invention relates to a management support method, a management support device, and a management support program.

### BACKGROUND

A layer-based operation management method is known as a method of managing the operations of a plurality of servers. In this layer-based operation management method, for example, monitoring definitions including information such as monitoring items are transmitted from a monitoring server (hereinafter also referred to as a management server) that performs monitoring to a plurality of monitoring target servers (hereinafter also referred to as management target servers or managed servers). Moreover, the monitoring target server transmits a notification to the monitoring server when the occurrence of an abnormal event based on the monitoring definitions, for example, is detected. By so doing, the monitoring server can understand the abnormal event occurred in the monitoring target server. In the layer-based operation management method, when the number of monitoring target servers increases, the information on operational management may be centralized in the monitoring server, and a monitoring load including the load on an operation administrator may increase.

In contrast, a method of monitoring the monitoring target servers by providing a reference server (hereinafter also referred to as a benchmark server) to a plurality of monitoring target servers made up of the same type of servers is known. In this reference server-based operation management method, for example, all applications installed in the monitoring target servers are installed in a reference server and are operated. Moreover, the operating state of the reference server is compared with the operating state of the monitoring target server to monitor the monitoring target server, and a detected abnormal event is notified to the monitoring server. Due to this, even when the number of monitoring target servers increases, an increase in a monitoring load can be suppressed. Examples of such an operation management method are disclosed in Japanese Patent Application Publication No. 2007-114983, Japanese Patent Application Publication No. 2005-258501, Japanese Patent Application Publication No. 2005-157862, and Japanese Patent Application Publication No. 2003-22188.

### SUMMARY

When some of the plurality of monitoring target servers have the versions of the applications upgraded, for example, the versions of the applications may become different between the monitoring target servers. In this case, for example, applications of different versions are not able to be operated simultaneously on one reference server. Due to this, the operation administrator may need to take such measures as to set up a new reference server, for example, in order to monitor applications of different versions. However, the new reference server is not able to be set up due to reasons such as the setup cost for the new reference server and the increased number of management steps.

According to an aspect of the embodiments, a management support method includes causing a first reference server to run a first application that is installed in each of a plurality of managed servers, causing a second reference to run a second application that is in an exclusive relation with the first application when the second application is present in any one of the plurality of managed servers, presenting a judgement result whether the second reference server is to be operated continuously by comparing an operating state of the first application on the first reference server and an operating state of the second application on the second reference server, selecting whether the first application or the second application is to be operated in the first reference server when the judgement result is that the second reference server is not to be operated continuously, and storing information on a difference in operation between an selected application which is selected in the selecting and an non-selected applications which are not selected in the selecting in a storage.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an entire configuration of an information processing system.

FIGS. 2 to 7 are diagrams for describing operational management of monitoring target servers by a benchmark server.

FIG. 8 is a diagram illustrating a hardware configuration of a physical machine.

FIG. 9 is a functional block diagram of a benchmark server that functions in the physical machine of FIG. 8.

FIG. 10 is a flowchart illustrating an outline of a management support process according to the first embodiment.

FIGS. 11 and 12 are diagrams for describing an outline of the management support process according to the first embodiment.

FIGS. 13 to 16 are flowcharts for describing the details of the management support process according to the first embodiment.

FIG. 17 is a diagram for describing the details of the management support process according to the first embodiment.

FIG. 18 is a diagram for describing a specific example of the server identification information.

FIGS. 19A to 19C are diagrams for describing a specific example of the comparison information.

FIGS. 20A and 20B are diagrams for describing a specific example of aggregate information.

FIG. 21 is a diagram for describing a specific example of monitoring target information.

FIG. 22 is a diagram for describing a case in which a new application is installed in a monitoring target server.

FIG. 23 is a diagram for describing a specific example of transmission information transmitted from the monitoring target server to the benchmark server.

FIG. 24 is a diagram for describing a specific example of the monitoring target information.

FIG. 25 is a diagram for describing a case in which a benchmark server operates an application.

FIGS. 26A and 26B are diagrams for describing a specific example of the information on the execution file that is operating in the benchmark server.

FIG. 27 is a diagram for describing a specific example of the determination result presented to the user.

FIGS. 28A and 28B are diagrams for describing a specific example of additional monitoring information and out-of-monitoring information.

FIGS. 29 to 31 are diagrams for describing a specific example of monitoring target information.

FIG. 32 is a diagram for describing correspondence between an exclusive application and an execution file.

### DESCRIPTION OF EMBODIMENTS

### Configuration of Information Processing System

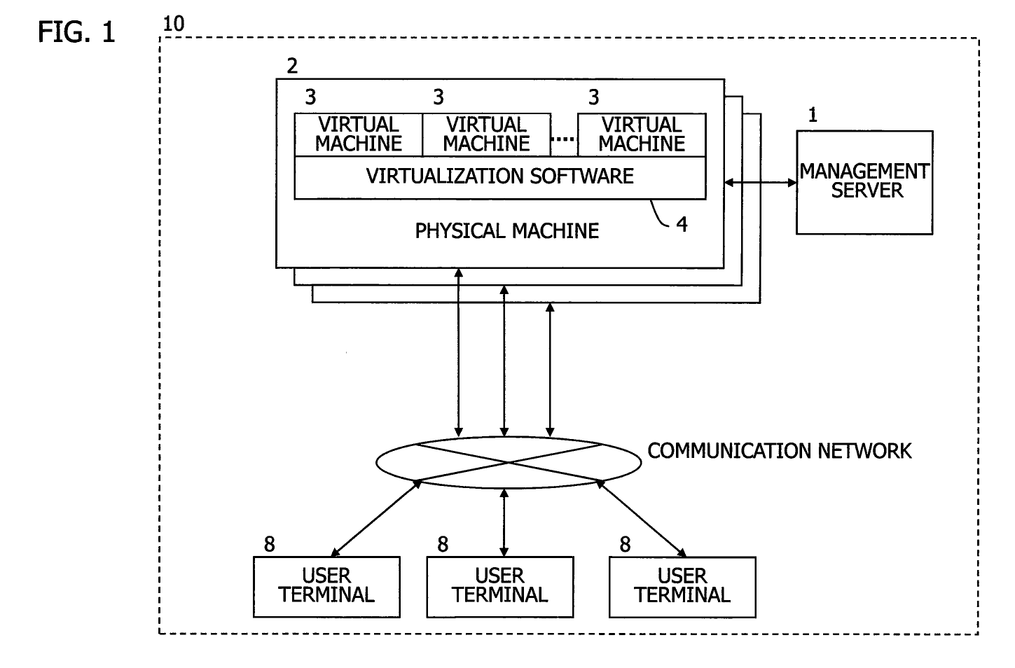

FIG. 1 is a diagram illustrating an entire configuration of an information processing system. In the information processing system 10 illustrated in FIG. 1, a management server 1 and a physical machine 2 that creates a virtual machine (VM) are provided in a data center, for example. Moreover, a user terminal 8 used by a user who uses a service can access the data center via a communication network such as the Internet or an intranet.

The physical machine 2 includes a plurality of physical machines in the example of FIG. 1, and each physical machine includes a central processing unit (CPU), a random access memory (RAM), a large capacity memory such as a hard disk drive (HOD), and a network. Moreover, the resources of the physical machine 2 are allocated to a plurality of virtual machines 3.

The management server 1 can access the physical machine 2, for example, and issues instructions for creation of the virtual machine 3 in the physical machine 2 and manages the created virtual machine 3. Moreover, the management server 1 performs operational management of a management target server by monitoring the operating state of the management target server, for example.

The virtual machine 3 is a machine by which a service provider provides its infrastructure to a user via a network, for example (this service is also referred to as a cloud service). A cloud service is a service of providing infrastructure (that is, infrastructure itself such as the virtual machine 3 or a network) for constructing and operating a computer system via a network. Moreover, a user accesses a cloud service portal site from the user terminal 8, for example, selects specifications needed for a virtual machine (for example, a CPU clock frequency, a memory volume (GB), a hard disk volume (MB/sec, IOPS), and a network communication bandwidth (Gbps)), and makes a contract for cloud service under these specifications. Moreover, the user terminal 8 allows a user to monitor an operating state of the virtual machine 3 and operate the virtual machine 3, for example.

Virtualization software 4 is infrastructure software that operates the virtual machine 3 by allocating the resources (such as a CPU, a memory, a hard disk, and a network) of the physical machine 2 according to instructions from the management server 1. The virtualization software 4 is operated by the physical machine 2, for example.

The virtual machine 3 is allocated with the resources of the physical machine 2 and has a hard disk in which an image file that includes an OS, middleware, applications, databases, and the like is stored. Moreover, the virtual machine 3 writes the image file from the hard disk to the memory during activation and performs an operation corresponding to a desired service.

[Operational Management of Monitoring Target Server]

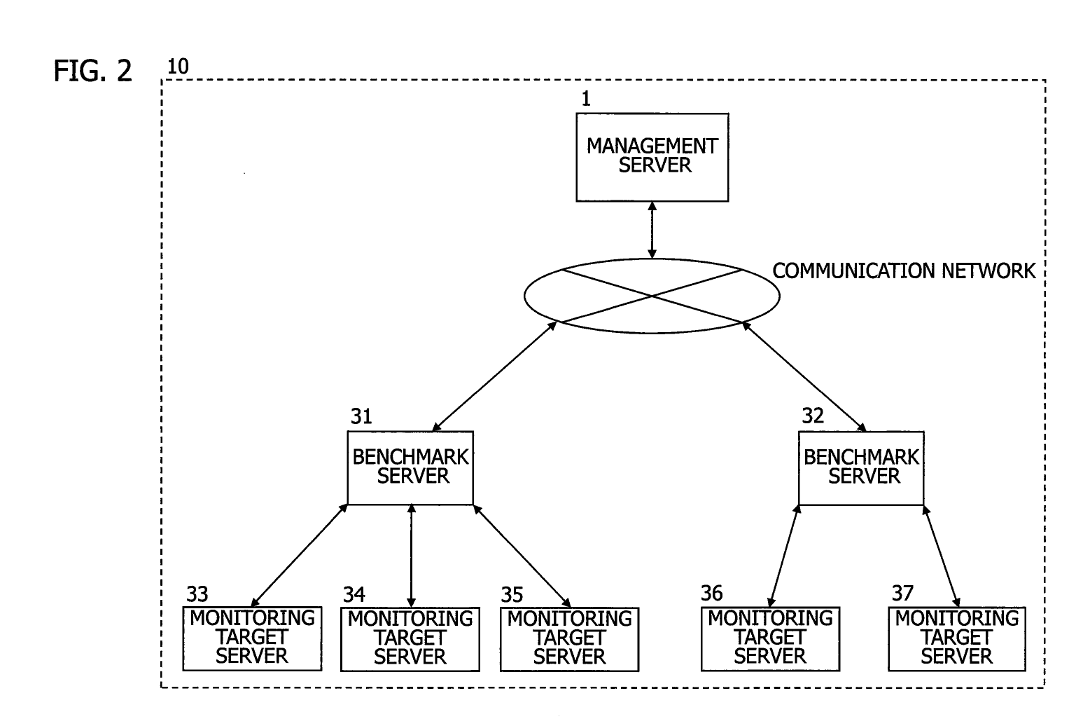

Next, operational management of monitoring target servers will be described. FIGS. 2 to 7 are diagrams for describing operational management of monitoring target servers by a benchmark server.

A monitoring target server is a server in which a business system for providing a service to a user is created, for example. The monitoring target server is a virtualized server, for example, and may be a portion of the virtual machine 3 illustrated in FIG. 1. Moreover, the monitoring target server may be the physical machine 2 itself illustrated in FIG. 2, for example.

A benchmark server is a server in which all applications installed in the monitoring target server are installed and operated. Moreover, the benchmark server performs operational management (monitoring) of the monitoring target server by comparing the operating state of an application installed in the benchmark server with the operating state of an application installed in the monitoring target server. The benchmark server is a virtualized server, for example, and may be a portion of the virtual machine 3 illustrated in FIG. 1. Moreover, the benchmark server may be the physical machine 2 itself illustrated in FIG. 1, for example. Hereinafter, a specific example of the operational management of the monitoring target server by the benchmark server will be described.

In the information processing system 10 illustrated in FIG. 2, a benchmark server 31 that monitors monitoring target servers 33, 34, and 35 and a benchmark server 32 that monitors monitoring target servers 36 and 37 are provided. When an abnormal event is detected in a monitoring target server, for example, the benchmark servers 31 and 32 transmit a notification on the detected abnormal event to the management server 1 via a network in the example of FIG. 2. Moreover, the management server 1 notifies the operation administrator of information (information on a server in which an abnormal event has occurred and information on the content of the abnormal event) on the detected abnormal event, for example.

The benchmark server may be provided for a plurality of monitoring target servers created based on the same template, for example. The template is information on a system created in the past by a service provider that provides a service to a user, for example. The service provider can create the same system as the system created in the past easily based on the template. Further, the benchmark server may be created based on a template that is created by the monitoring target server. By doing so, since the difference in the configuration between the benchmark server and the monitoring target servers can be reduced, the operational management can be performed efficiently. Hereinafter, a specific example of the applications installed in the respective servers of the information processing system 10 will be described.

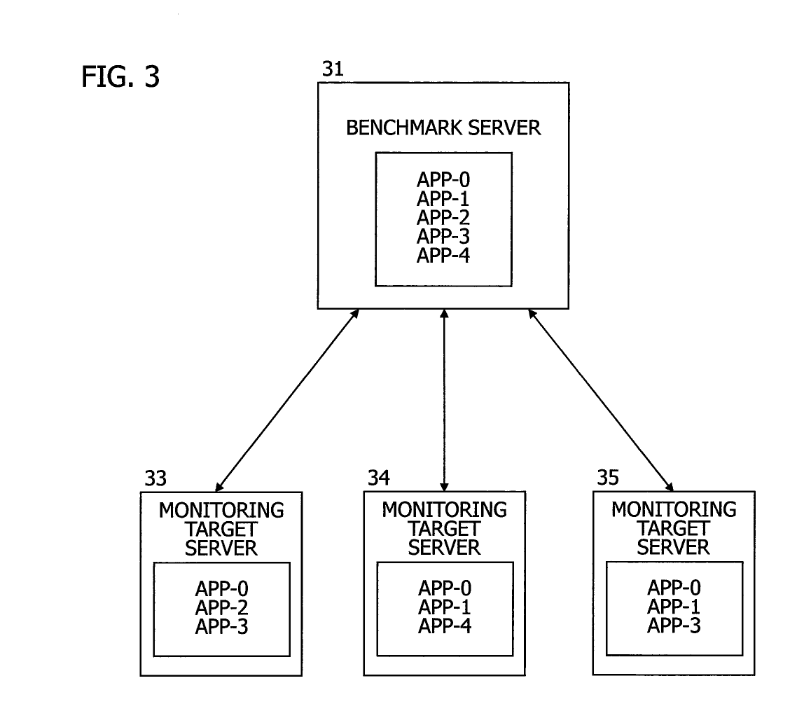

FIG. 3 is a diagram for describing a relation between the applications installed in the benchmark server 31 and the monitoring target servers 33, 34, and 35. In the example illustrated in FIG. 3, applications APP-0, APP-2, and APP-3 are installed in the monitoring target server 33. Moreover, applications APP-0, APP-1, and APP-4 are installed in the monitoring target server 34, and applications APP-0, APP-1, and APP-3 are installed in the monitoring target server 35. Moreover, in the benchmark server 31, applications APP-0, APP-1, APP-2, APP-3, and APP-4 that are all applications installed in the monitoring target servers are installed.

The benchmark server 31 operates the same applications as the applications being operated by the respective monitoring target servers. Moreover, the benchmark server 31 compares the operating state of an application installed in the benchmark server 31 and the operating state of an application installed in the monitoring target server. In this way, when a difference in the compared operating state occurs, the benchmark server 31 can detect the difference. For example, in the example of FIG. 3, when there is a difference in the operating state between the application APP-3 of the benchmark server 31 and the application APP-3 of the monitoring target server 33, the benchmark server 31 can detect that there is a possibility of the occurrence of an abnormal event in the monitoring target server 33.

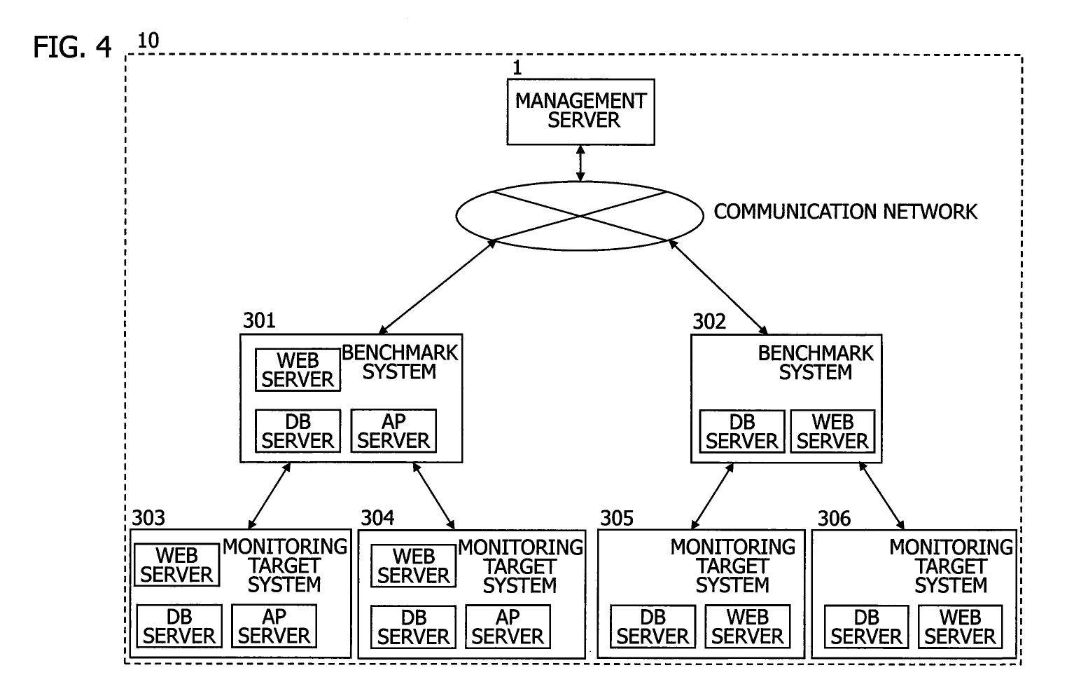

Next, a case in which a benchmark system including a plurality of benchmark servers performs operational management of a monitoring target system including a plurality of monitoring target servers will be described. FIG. 4 is a specific example of a case in which a benchmark system monitors a monitoring target system. An operation administrator may sometimes create a business system or the like in such a form of including a plurality of servers depending on the content of a service provided to a user. In this case, as illustrated in FIG. 4, the operation administrator performs operational management of a monitoring target system including a plurality of monitoring target servers by providing a benchmark system that includes a plurality of benchmark servers.

Specifically, in the example illustrated in FIG. 4, a benchmark system 301 monitors monitoring target systems 303 and 304, and a benchmark system 302 monitors monitoring target systems 305 and 306. Moreover, in the example illustrated in FIG. 4, the benchmark system 301 and the monitoring target systems 303 and 304 each include a Web server, a DB server, and an AP server. Moreover, the benchmark system 302 and the monitoring target system 305 and 306 each include a Web server and a DB server. Further, the respective servers included in the benchmark system have installed therein all applications that are installed in the corresponding servers included in the monitoring target system. For example, all applications installed in the DB server of the monitoring target system 303 and the DB server of the monitoring target system 304 are installed in the DB server of the benchmark system 301. That is, the respective servers included in the benchmark system illustrated in FIG. 4 function similarly to the benchmark server described in FIG. 2. Hereinafter, a specific example of a case in which a notification is transmitted between respective servers of the information processing system 10 of FIG. 4 will be described.

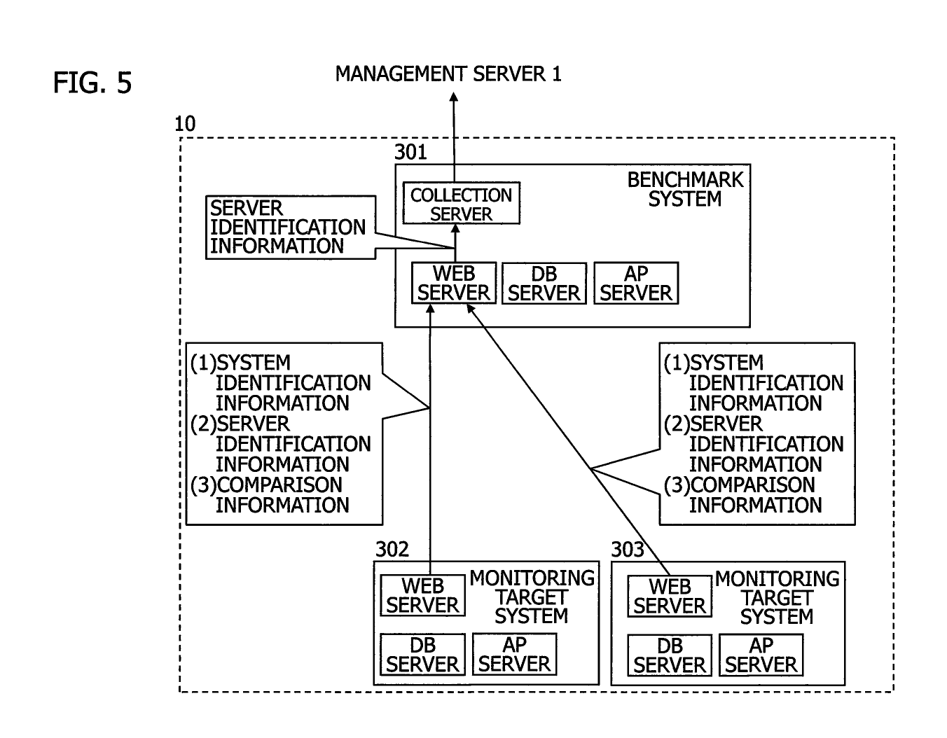

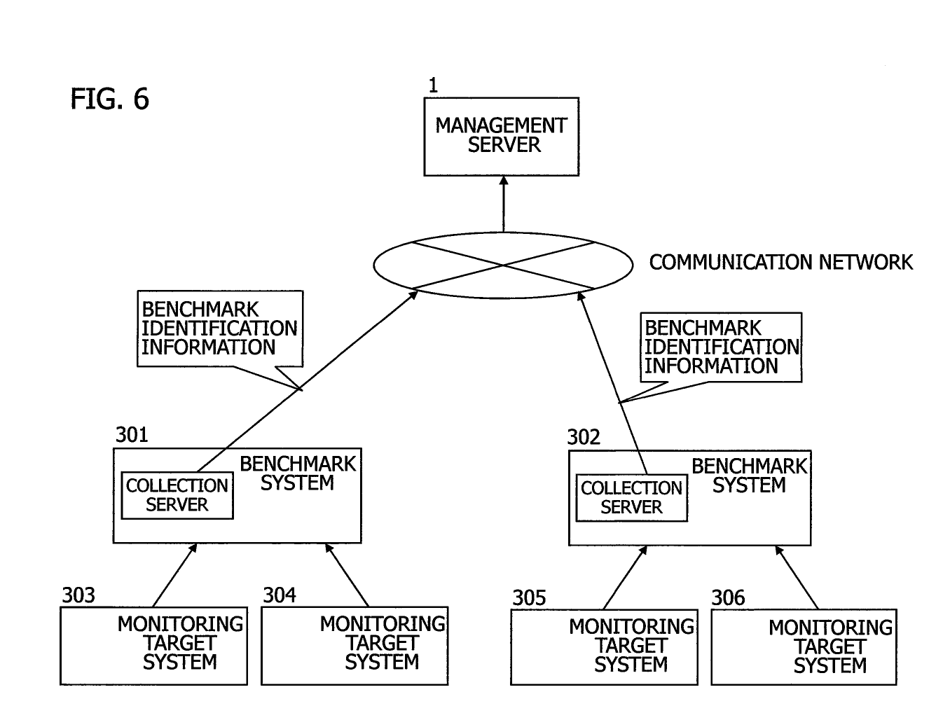

FIGS. 5 and 6 are diagrams for describing a specific example of a case of transmitting a notification between respective servers. Each server in the monitoring target system transmits an operating state of the target server to the benchmark server in the benchmark system every predetermined time, for example. Specifically, in the example illustrated in FIG. 5, each of the Web servers of the monitoring target systems 302 and 303 transmits the operating state of the Web server (the benchmark server) of the benchmark system 301. The operating state may include identification information for identifying a monitoring target system, identification information for identifying a server, and comparison information as illustrated in FIG. 5. The comparison information may include a CPU usage rate and a memory usage rate of the entire server, a CPU usage rate and a memory user of respective applications, an output application log, an output system log, and the like, for example. Specific examples of the comparison information will be described later.

Subsequently, in the example of FIG. 5, the Web server of the benchmark system 301 having received the operating states from the Web servers of the monitoring target systems 302 and 303 compares the received operating states with the operating state of the benchmark system 301. When it is determined that an abnormal event has occurred in the monitoring target server, the Web server of the benchmark system 301 transmits the identification information of the server in which the abnormal event is detected, for example, to a collection server in the benchmark system 301. In the example of FIG. 5, the collection server is a server that collects information on the abnormal events detected by the respective servers of the benchmark system 301 and transmits the collected information to the management server 1. Although the collection server is a server that is independent from other servers of the benchmark system 301 in the example of FIG. 5, another server (for example, a Web server or the like) may function as the collection server.

When it is detected that a server in which an abnormal event has occurred is present in the monitoring target system, the collection server of the benchmark system 301 transmits benchmark identification information for identifying the benchmark system 301 to the management server 1 as illustrated in FIG. 6, for example. The benchmark identification information does not need to be transmitted when no abnormal event is detected in the servers of the monitoring target system, for example. By doing so, the management server 1 can reduce the load of monitoring the monitoring target system.

Further, upon receiving the benchmark identification information, for example, the management server 1 acquires detailed information on a server in which an abnormal event has occurred from the benchmark system that transmitted the benchmark identification information. Moreover, the management server 1 transmits a notification to the operation administrator based on the acquired detailed information, for example.

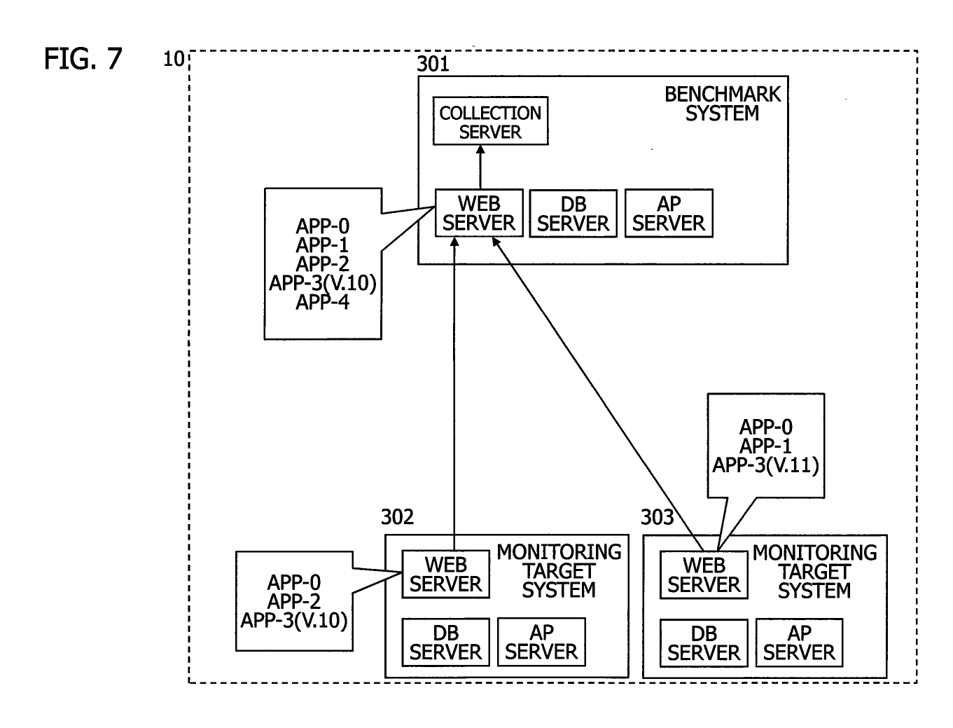

Here, when some monitoring target servers of the information processing system 10 described in FIG. 2 and the like have the versions of the applications upgraded, the versions of the installed applications may become different between the monitoring target servers. Specifically, as illustrated in FIG. 7, this is a case in which application APP-3 (version 10 (hereinafter denoted by V.10)) and application APP-3 (V.11) are installed in the Web servers of the monitoring target systems 302 and 303 respectively. In such a case, the Web server of the benchmark system 301 may be unable to install both applications APP-3 (V.10) and APP-3 (V.11) due to reasons such as inability to guarantee proper operations of applications. Due to this, the operation administrator needs to take such measures as to set up a new benchmark server, for example, in order to monitor a plurality of applications of different versions. However, the new server is not able to be set up due to reasons such as the setup cost for the new server and the increased number of management steps.

Thus, in the present embodiment, a benchmark server (hereinafter also referred to as a first benchmark server) causes a plurality of applications that is in an exclusive relation, be operated in another benchmark server. Moreover, the first benchmark server presents a determination result (hereinafter also referred to as a judgement result) on whether the other benchmark server (hereinafter also referred to as a second benchmark server) is to be operated continuously based on the operating state of the other application. When it is determined that the second benchmark server is not to be operated continuously, the first benchmark server selects an application that is operated in the first benchmark server and stores a difference from applications that are not selected. In this way, the first benchmark server can monitor a plurality of applications that is in an exclusive relation.

[Hardware Configuration of Physical Machine]

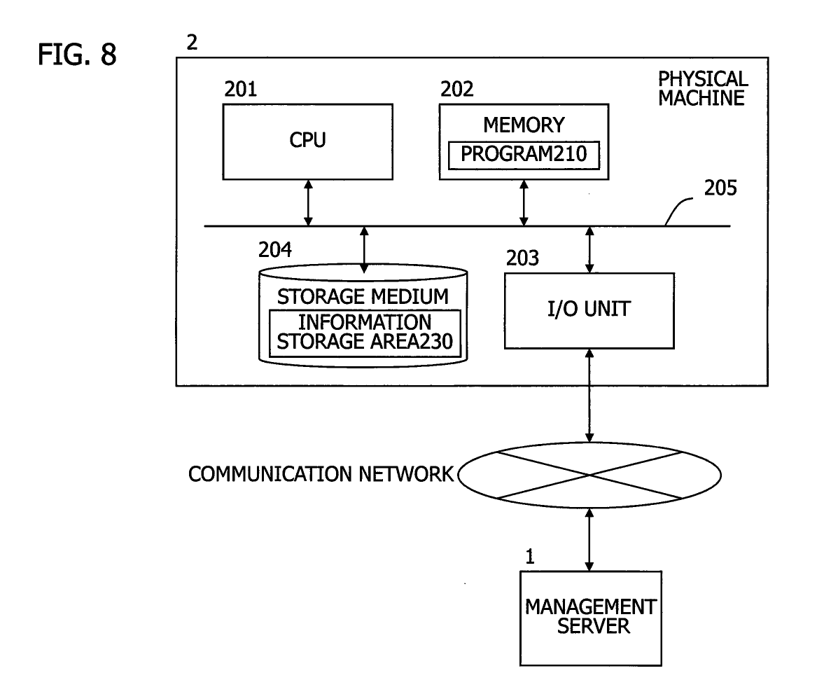

First, a configuration of the physical machine 2 will be described. FIG. 8 is a diagram illustrating a hardware configuration of a physical machine. The physical machine 2 includes a CPU 201 which is a processor, a memory 202, an external interface (I/O unit) 203, a storage medium 204. These respective components are connected by a bus 205. The storage medium 204 stores a program for performing a process of creating the virtual machine 3 in the physical machine 2 in a program storage area (not illustrated) in the storage medium 204, for example. Moreover, the storage medium 204 stores a program 210 (hereinafter also referred to as a management support program) for performing a process (hereinafter also referred to as a management support process) for supporting the monitoring of the virtual machine 3 in a program storage area (not illustrated) in the storage medium 204, for example. As illustrated in FIG. 8, the CPU 201 loads the program 210 from the storage medium 204 to the memory 202 during execution of the program 210 and performs the management support process in cooperation with the program 210. Moreover, the storage medium 204 has an information storage area 230 (hereinafter also referred to as a storage unit 230) for storing information used when the management support process is performed, for example.

In the example of FIG. 8, the virtual machine 3 created by the resources of the physical machine 2, for example, functions as a first or a second benchmark server described later. Moreover, these benchmark servers perform operational management of other virtual machines 3 (monitoring target servers) created in the physical machine 2, for example. Moreover, for example, the physical machine 2 itself may function as a benchmark server and perform operational management of virtual machines created in other physical machines.

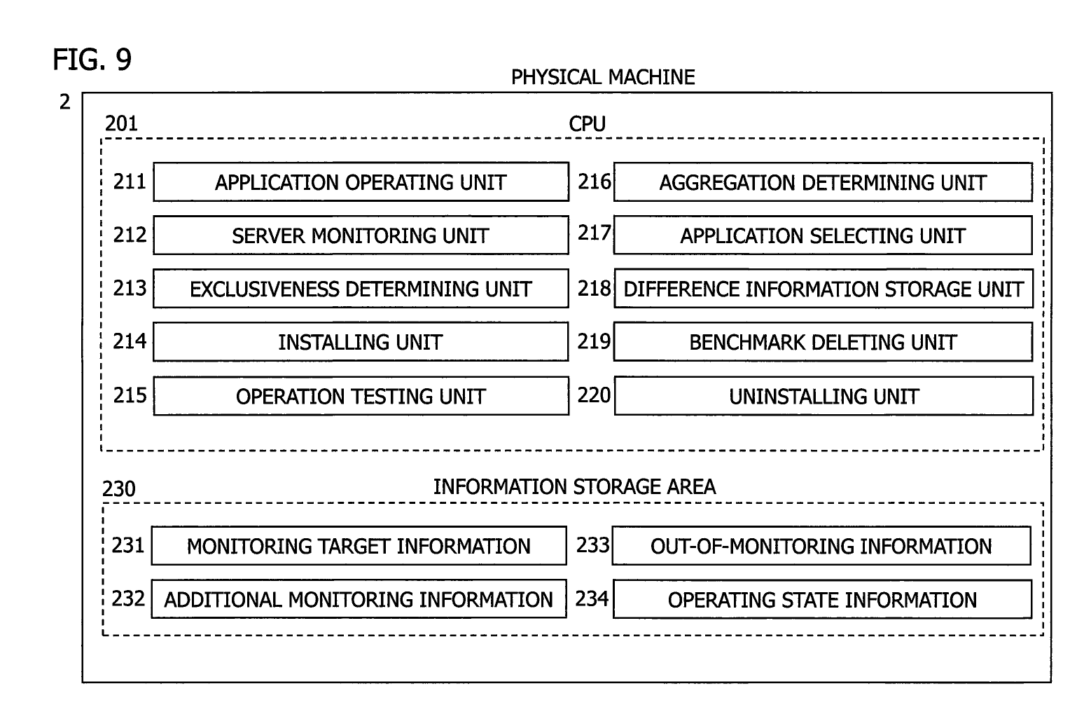

FIG. 9 is a functional block diagram of a benchmark server that functions in the physical machine of FIG. 8. The CPU 201 operates as an application operating unit 211, a server monitoring unit 212, an exclusiveness determining unit 213, an installing unit 214, and an operation testing unit 215, for example, by cooperating with the program 210. Moreover, the CPU 201 also operates as an aggregation determining unit 216 (hereinafter also referred to simply as a determining unit), an application selecting unit 217 (hereinafter also referred to simply as a selecting unit), a difference information storage unit 218, a benchmark deleting unit 219, and an uninstalling unit 220, for example, by cooperating with the program 210. Moreover, monitoring target information 231, additional monitoring information 232, out-of-monitoring information 233, and operating state information 234, for example, are stored in the information storage area 230.

The application operating unit 211 operates an application that operates in a monitoring target server that is managed by the benchmark server, for example.

The server monitoring unit 212 receives the operating states from the respective monitoring target servers, for example, and compares the operating states received from the monitoring target servers with the operating state which is the result obtained by the application operating unit 211 executing the application. When an abnormal event is detected from the operating state comparison result, for example, the server monitoring unit 212 transmits information on the abnormal event to the management server 1. The server monitoring unit 212 may check whether the operating state has been received from all monitoring target servers by referring to the monitoring target information 231 which is information on the monitoring target server, for example.

The exclusiveness determining unit 213 checks whether a new application that is not installed in the first benchmark server is present in any one of the plurality of monitoring target servers, for example. Further, the exclusiveness determining unit 213 detects whether the new application (hereinafter also referred to as a second application) is in an exclusive relation with an application (hereinafter also referred to as a first application) that has been installed and operated in the first benchmark server, for example. The application being in the exclusive relation is a plurality of applications that is not able to be installed simultaneously in one server due to reasons such as inability to guarantee proper operations of applications, for example. Specifically, the same applications having different versions correspond to the applications being in the exclusive relation. When the second application is present, for example, the exclusiveness determining unit 213 instructs the operation testing unit 215 described later so that the second application is operated in the second benchmark server. Hereinafter, the application being in the exclusive relation will be also referred to as an exclusive application.

When it is determined that a new application installed in the monitoring target server, for example, is an application that is not in the exclusive relation with the first application, the installing unit 214 installs the new application installed in the monitoring target server in the first benchmark server.

The operation testing unit 215 installs the second application in the second benchmark server so that the second application is operated in the second benchmark server based on the instructions of the exclusiveness determining unit 213, for example. Moreover, the operation testing unit 215 acquires the operating state of the second application that is operated in the second benchmark server, for example.

The aggregation determining unit 216 presents a determination result on whether the second benchmark server is to be operated continuously based on the comparison result between the operating state of the first application on the first benchmark server and the operating state of the second application on the second benchmark server. For example, the aggregation determining unit 216 presents the determination result to a user by outputting the determination result. Moreover, the user determines whether the second benchmark server is to be operated continuously based on the content presented by the aggregation determining unit 216, for example.

When it is determined that the second benchmark server is not to be operated continuously, for example, the application selecting unit 217 selects whether the first application or the second application is used as an application to be operated in the first benchmark server.

The difference information storage unit 218 stores information on a difference in operation between the selected application and the application that is not selected by the application selecting unit 217, for example, in the information storage area 230 as the operating state information 234. The information on a difference in operation may be an operating state of an execution file (hereinafter also referred to as a difference execution file) that is not included in execution files that are executed in association with execution of the selected application among the execution files executed in association with execution of applications that are not selected, for example.

Moreover, the difference information storage unit 218 may store information on an execution file that is not included in execution files that are executed in association with execution of the selected application among the execution files executed in association with execution of applications that are not selected, for example, as the additional monitoring information 232. Further, the difference information storage unit 218 may store information on an execution file that is not included in execution files that are executed in association with execution of applications that are not selected among the execution files executed in association with execution of the selected application, for example, as the out-of-monitoring information 233.

When the aggregation determining unit 216 determines that the second benchmark server is not to be operated continuously, for example, the benchmark deleting unit 219 deletes the second benchmark server.

When the application selected by the application selecting unit 217 is uninstalled from all of the plurality of monitoring target servers, for example, the uninstalling unit 220 uninstalls the selected application from the first benchmark server.

### First Embodiment

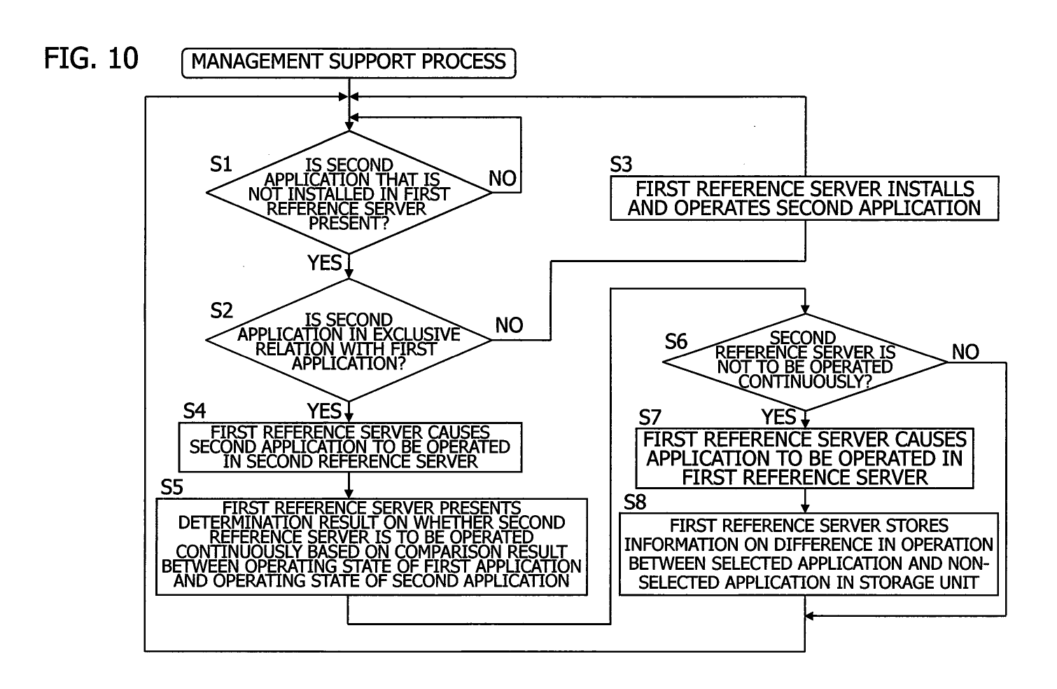

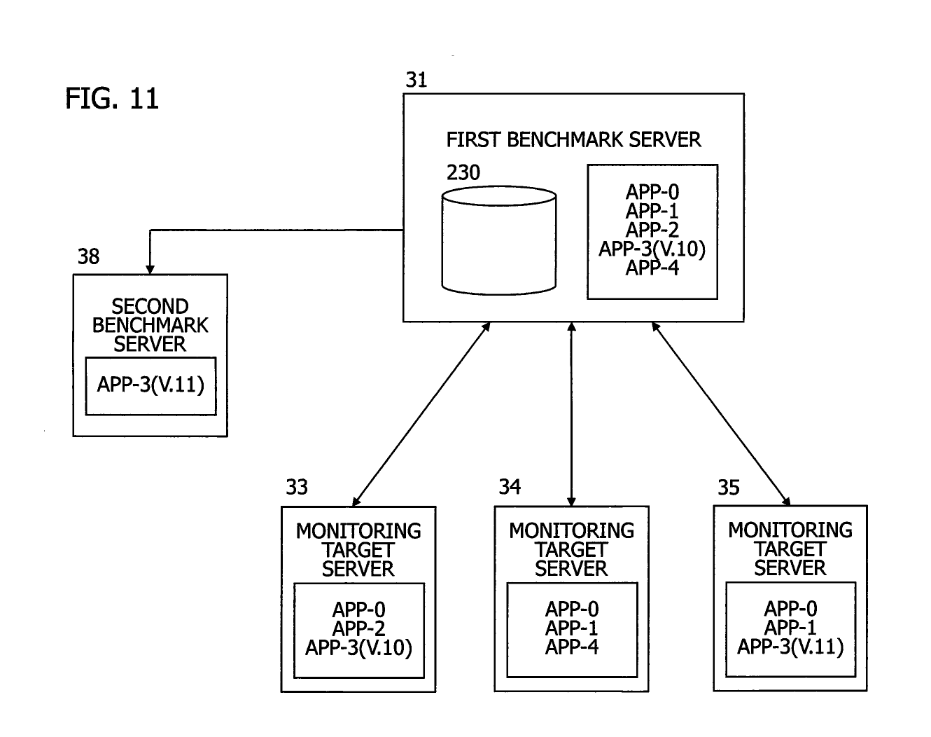

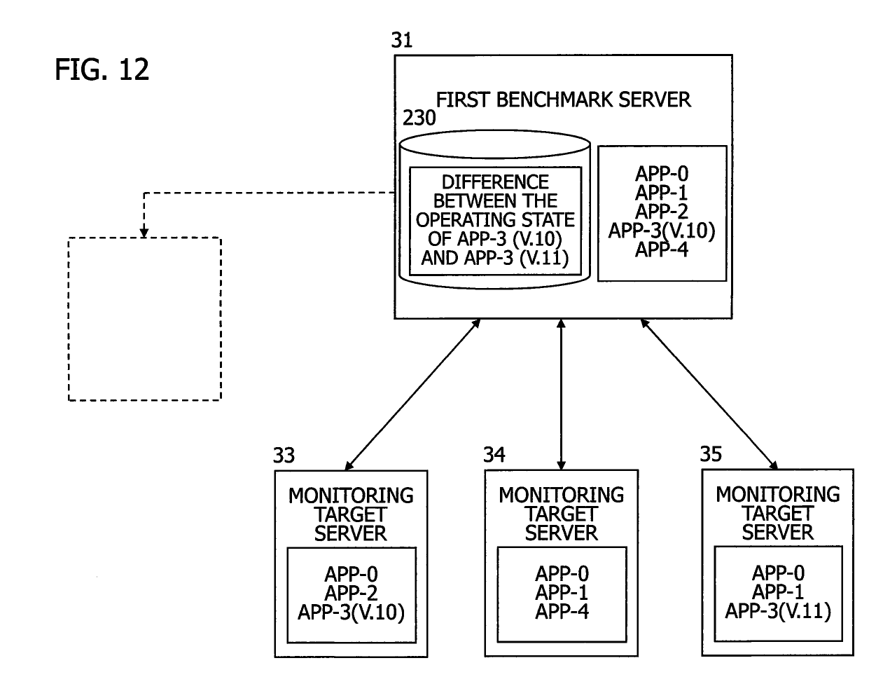

Next, a first embodiment will be described. FIG. 10 is a flowchart illustrating an outline of a management support process according to the first embodiment. FIGS. 11 and 12 are diagrams for describing an outline of the management support process according to the first embodiment. An outline of the management support process of FIG. 10 will be described with reference to FIGS. 11 and 12.

FIG. 11 is an example of a case in which the first benchmark server 31 performs operational management of the monitoring target servers 33, 34, and 35. In the example of FIG. 11, applications APP-0, APP-2, APP-3 (V.10) are installed in the monitoring target server 33. Moreover, applications APP-0, APP-1, and APP-4 are installed in the monitoring target server 34, and applications APP-0, APP-1, and APP-3 (V.11) are installed in the monitoring target server 35. Moreover, applications APP-0, APP-1, APP-2, APP-3 (V.10), and APP-4 are installed in the first benchmark server 31. Further, in the example illustrated in FIG. 11, a second benchmark server 38 is installed as a benchmark server in addition to the first benchmark server 31. Hereinafter, an outline of the management support process will be described.

[Flowchart of Outline of Management Support Process]

First, as illustrated in FIG. 10, the first benchmark server 31 (hereinafter also referred to as a first reference server 31) checks whether a second application that is not installed in the first benchmark server 31 is present in a monitoring target server, for example (S1). The first benchmark server 31 may acquire information on an application that operates in the monitoring target server by accessing the monitoring target server, for example. Moreover, the first benchmark server 31 may receive information on an application that operates in the respective monitoring target servers periodically from the monitoring target servers, for example. Specifically, in the example of FIG. 11, the application APP-3 (V.11) is installed in the monitoring target server 35 but is not installed in the first benchmark server 31. Thus, the first benchmark server 31 acquires information indicating that the application APP-3 (V.11) which is a new application is installed from the monitoring target server 35.

When the second application that is not installed in the first benchmark server 31 is present (S1: YES), the first benchmark server 31 checks whether it is possible to install the second application in the first benchmark server 31, for example (S2). That is, it is checked whether the second application is in an exclusive relation with the first application that is already installed in the first benchmark server 31. When the second application is not in the exclusive relation with the first application (S2: NO), the first benchmark server 31 installs the second application in the first benchmark server 31 and operates the second application (S3). That is, the first benchmark server 31 of the present embodiment continuously acquires information on an application that operates in the monitoring target server. When it is checked that a new application is installed in any one of the monitoring target servers, the first benchmark server 31 installs the application. In this way, the first benchmark system can install the same application as the application that is installed in the monitoring target server and operate the application. Moreover, the first benchmark server 31 can appropriately perform operational management of the applications installed in the monitoring target servers.

On the other hand, when it is determined that the second application is in the exclusive relation with the first application (S2: YES), the first benchmark server 31 causes the second application to be operated in the second benchmark server 38 (hereinafter also referred to as a second reference server 38) as illustrated in FIG. 11, for example (S4). That is, there is a case in which a plurality of applications that is in the exclusive relation is not able to be installed and operated in one benchmark server due to reasons such as inability to guarantee normal operations of the applications. Due to this, when it is determined that the second application is in the exclusive relation with the first application (S3: YES), the first benchmark server 31 causes the exclusive application of the first application to be operated in another benchmark server (S4).

Specifically, in the example of FIG. 11, when the first benchmark server 31 receives information indicating that the application APP-3 (V.11) is installed in the monitoring target server 35, the first benchmark server 31 refers to the information (not illustrated) on the exclusive relation, for example. Moreover, the first benchmark server 31 checks whether an application that is in the exclusive relation with the application APP-3 (V.11) is present among the applications that are already installed in the first benchmark server 31, for example. In the example illustrated in FIG. 11, an application APP-3 (V.10) that is the same application with a different version from the version of the application APP-3 (V.11) is installed in the first benchmark server 31. Due to this, the first benchmark server 31 determines that the application APP-3 (V.10) that is in the exclusive relation with the application APP-3 (V.11), for example, is installed (S2: YES). The first benchmark server 31 causes the application APP-3 (V.11) to be operated in the second benchmark server as illustrated in FIG. 11 (S4).

Returning to FIG. 10, the first benchmark server 31 acquires the operating state of the first application in the first benchmark server 31 and the operating state of the second application in the second benchmark server 38. Moreover, the first benchmark server 31 determines whether the second benchmark server 38 is to be operated continuously based on the result of comparison between these operating states and presents the determination result (S5). That is, the first benchmark server 31 of the present embodiment prepares information needed for determining whether the second benchmark server 38 is to be operated continuously based on the operating states of the first and second applications. The first benchmark server 31 presents a user with the prepared information (determination result) and asks the user whether the second benchmark server 38 is to be operated continuously. By doing so, the user can determine whether the second benchmark server 38 is to be operated continuously based on the information prepared by the first benchmark server 31.

The determination on whether the second benchmark server 38 is to be operated continuously may be made based on information on an execution file executed in association with execution of the first application and an execution file executed in association with execution of the second application, for example. Specifically, the first benchmark server 31 calculates a proportion (hereinafter also referred to as a degree of difference) of the execution file executed in association with execution of the first application among the execution files executed in association with execution of the second application, for example. When the calculated degree of difference is lower than a predetermined first threshold (for example, 0.4), for example, the first benchmark server 31 may determine that the second benchmark server 38 is to be operated continuously and may present the determination result. The first benchmark server 31 may determine whether the second benchmark server 38 is to be operated continuously based on the determination result in S5 without presenting the determination result to the user, for example.

Subsequently, when the user determines that the second benchmark server 38 is not to be operated continuously (S6: YES), the first benchmark server 31 selects an application to be operated in the first benchmark server 31 among the first and second applications and operates the selected application, for example (S7). Moreover, the first benchmark server 31 stores information on a difference in operation between the selected application and the non-selected application in the information storage area 230, for example (S8). Specifically, as illustrated in FIG. 12, for example, when it is determined that the application APP-3 (V.11) is not to be operated continuously in the second benchmark server 38, the first benchmark server 31 selects an application to be operated in the first benchmark server 31. When the first benchmark server 31 selects the application APP-3 (V.10), the first benchmark server 31 operates the application APP-3 (V10) continuously as illustrated in FIG. 12 (S7). In this case, the first benchmark server 31 stores a difference between the operating state of the application APP-3 (V.11) and the operating state of the application APP-3 (V10) acquired in S5 in the information storage area 230. For example, the first benchmark server 31 stores an operating state of an execution file that is not included in execution files that are executed in association with execution of the application APP-3 (V.10) among the execution files executed in association with execution of the application APP-3 (V.11).

On the other hand, when the application APP-3 (V.11) is selected, the first benchmark server 31 uninstalls the application APP-3 (V.10) and installs and operates the application APP-3 (V.11) (S7). Also in this case, the first benchmark server 31 stores a difference between the operating state of the application APP-3 (V.11) and the operating state of the application APP-3 (V10) acquired in S5 in the information storage area 230.

That is, the first benchmark server 31 is not able to install both the first and second applications that are in the exclusive relation in the first benchmark server 31. Due to this, the first benchmark server 31 installs and operates the selected application only among the first and second applications. Further, the first benchmark server 31 stores a difference between the operating state of the selected application and the operating state of the non-selected application. By doing so, the selected application can be monitored by comparing the operating state of the selected application operating in the benchmark server with the operating state of the selected application operating in the monitoring target server. Moreover, the non-selected application can be monitored by comparing the operating state of the selected application operating in the benchmark server and the operating state of the stored difference with the operating state of the non-selected application operating in the monitoring target server. Due to this, according to the present embodiment, a plurality of applications being in the exclusive relation can be monitored by one benchmark server in a centralized manner. Thus, the operation administrator can reduce the cost and labor associated with preparing a plurality of benchmark servers.

On the other hand, when the user determines that the second benchmark server 38 is to be operated continuously (S6: NO), the first benchmark server 31 operates the first application continuously and the second benchmark server 38 operates the second application continuously.

In this manner, according to the first embodiment, the first benchmark server 31 determines whether the second application that is in the exclusive relation with the first application operating in the first benchmark server 31 is present in any one of the plurality of management target servers. When the second application is present, the first benchmark server 31 causes the second application to be operated in the second benchmark server 38. Subsequently, the first benchmark server 31 compares the operating state of the first application on the first benchmark server 31 with the operating state of the second application on the second benchmark server 38. Moreover, the first benchmark server 31 determines whether the second benchmark server 38 is to be operated continuously based on the comparison result and presents the determination result.

Further, when it is determined that the second benchmark server 38 is not to be operated continuously, the first benchmark server 31 selects whether the first application or the second application is used as an application to be operated in the first benchmark server 31. Moreover, the first benchmark server 31 stores information on a difference in the operation between the selected application and the non-selected application in the storage unit 230.

This is, when the first benchmark server 31 determines that the second benchmark server 38 is not to be operated continuously, the first benchmark server 31 performs operational management of a plurality of applications that is in the exclusive relation. Due to this, the operation administrator does not need to prepare a new benchmark server every time an application that is in the exclusive relation with the first application operating in the first benchmark server 31 is installed in the monitoring target server. Thus, the operation administrator can reduce the cost and labor associated with preparing of a new benchmark server.

[Details of First Embodiment]

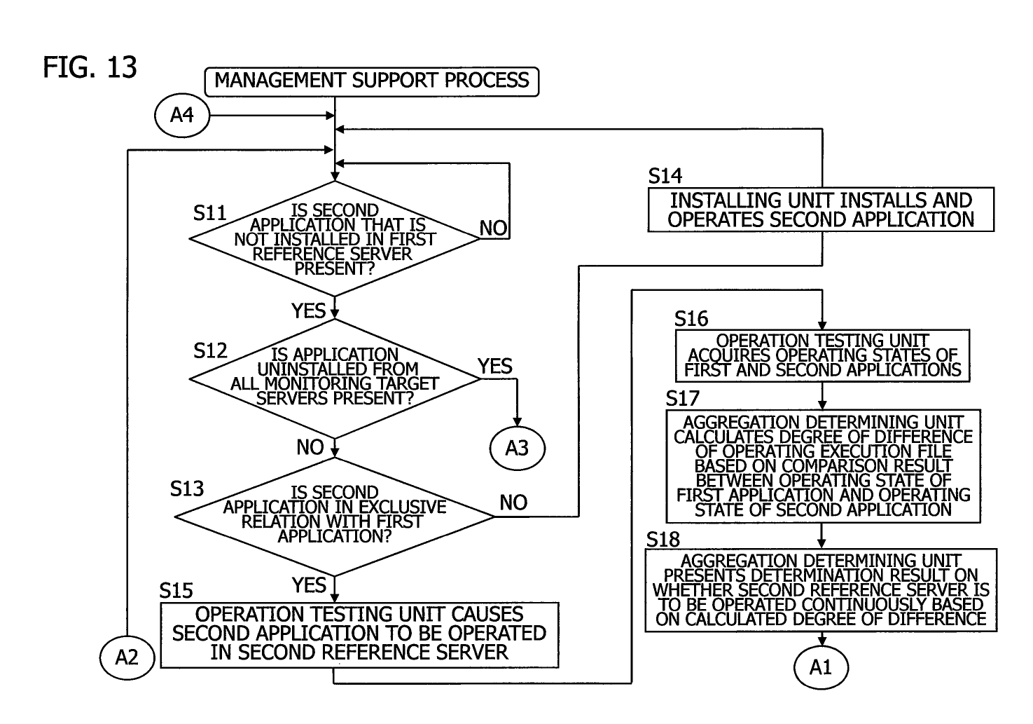

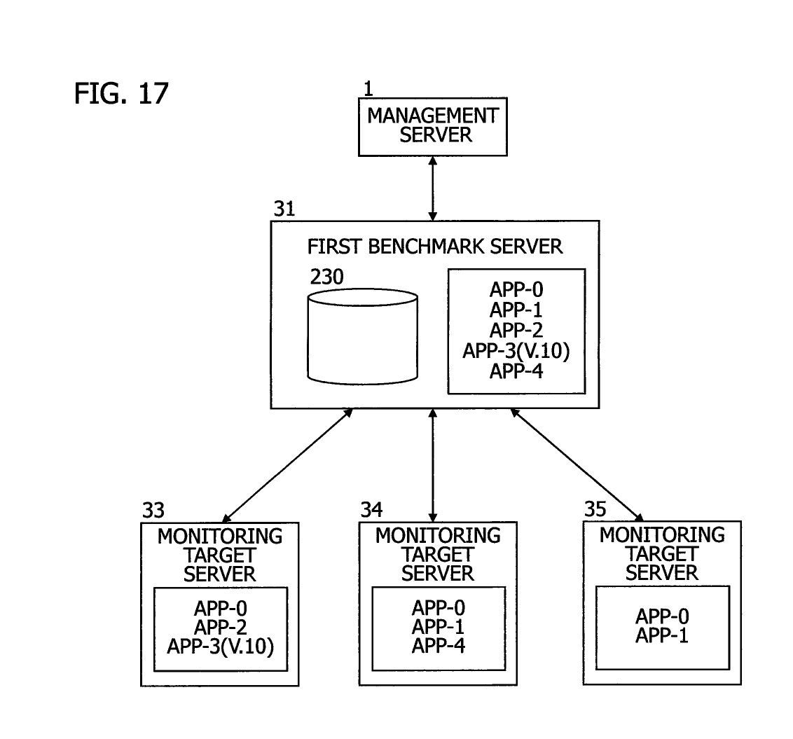

Next, the details of the first embodiment will be described. FIGS. 13 to 16 are flowcharts for describing the details of the management support process according to the first embodiment. Moreover, FIGS. 17 to 32 are diagrams for describing the details of the management support process according to the first embodiment. The details of the management support process of FIGS. 13 to 16 will be described with reference to FIGS. 17 to 32.

[Specific Example of Operational Management by Benchmark Server]

First, a specific example of the operational management of the monitoring target servers by the benchmark server 31 will be described with reference to FIG. 17.

In the example illustrated in FIG. 17, applications APP-0, APP-2, and APP-3 (V.10) are installed in the monitoring target server 33. Moreover, applications APP-0, APP-1, and APP-4 are installed in the monitoring target server 34, and applications APP-0 and APP-1 are installed in the monitoring target server 35. Moreover, applications APP-0, APP-1, APP-2, APP-3 (V.10), and APP-4 that are all applications installed in the monitoring target servers are installed in the first benchmark server 31. The first benchmark server 31 transmits information on the detected abnormal event to the management server 1 similarly to that described in connection with FIG. 2 and the like. In the example of FIG. 17, the respective monitoring target servers transmit information on the respective monitoring target servers to the first benchmark server 31 every predetermined time interval, for example. The monitoring target information is the server identification information and the comparison information described in connection with FIGS. 5 and 6, for example. Hereinafter, the monitoring target servers 33, 34, and 35 will be also denoted by a Web1-1-1, a Web1-1-2, and a Web1-1-3, respectively.

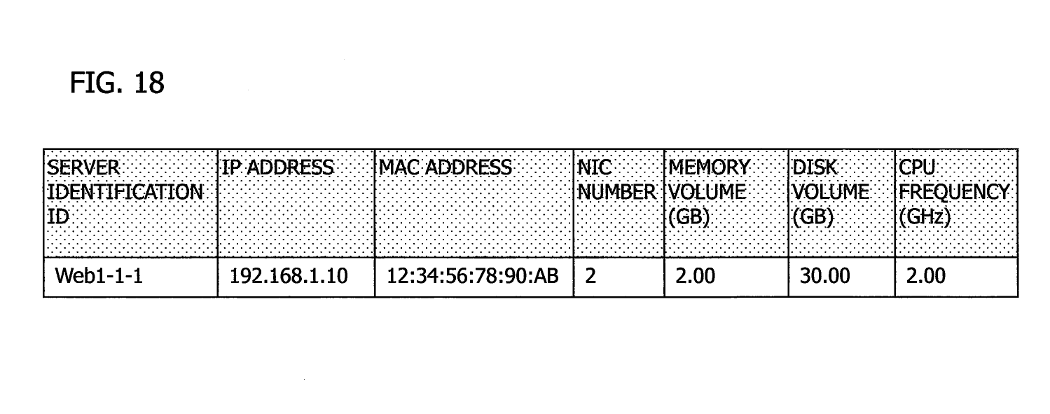

FIG. 18 is a diagram for describing a specific example of the server identification information. The monitoring target server transmits, to the first benchmark server 31, the server identification information illustrated in FIG. 18 and the comparison information described later, for example, in association with each other. With this, the first benchmark server 31 can identify a monitoring target server, which has transmitted the received information. The server identification information illustrated in FIG. 18 has a “server identification ID” for identifying a monitoring target server that transmitted the identification information and an “IP address” which is the IP address of the monitoring target server, for example, as its items. Moreover, the identification information illustrated in FIG. 18 has a “MAC address” which is the MAC address of a physical NIC or a virtual NIC of the monitoring target server, a “NIC number” indicating the number of physical NICs or virtual NICs, and a “memory volume (GB)” which is the memory volume of the monitoring target server as its items. Further, the identification information illustrated in FIG. 18 has a “disk volume (GB)” which is the disk volume of the monitoring target server and a “CPU frequency” which is the CPU frequency of the monitoring target server as its items. Specifically, the server identification information illustrated in FIG. 18 has a “server identification ID” of Web1-1-1, an “IP address” of 192.168.1.10, and an “MAC address” of 12:34:56:78:90:AB. Moreover, the server identification information illustrated in FIG. 18 has a “NIC number” of 2, a “memory volume (GB)” of 2.00, a “disk volume (GB)” of 30.00, and a “CPU frequency ((3 Hz)” of 2.00.

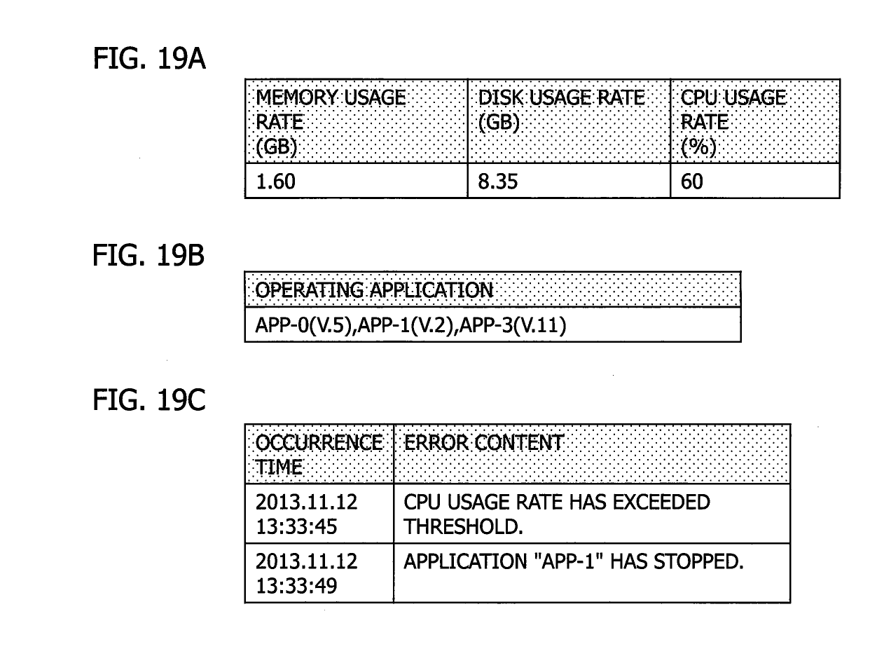

Moreover, FIGS. 19A to 19C are diagrams for describing a specific example of the comparison information. The comparison information illustrated in FIG. 19A has a “memory usage (GB)” which is the present memory usage of the monitoring target server, a “disk usage (GB)” which is the present disk usage of the monitoring target server, and a “CPU usage rate (%)” which is the present CPU usage rate of the monitoring target server as its items. Specifically, the comparison information illustrated in FIG. 19A has a “memory usage (GB)” of 1.60, a “disk usage (GB)” of 8.35, and a “CPU usage rate (%)” of 60.

The first benchmark server 31 compares the respective monitoring target servers based on the comparison information of FIG. 19A, for example, and detects an abnormal event in the monitoring target server. For example, when the value of the “memory usage (GB)” of a certain monitoring target server is two times or more than an average of the “memory usage (GB)” of other monitoring target servers, the first benchmark server 31 may detect that an abnormal event has occurred in the monitoring target server.

The comparison information illustrated in FIG. 196 has an “operating application” indicating applications that are operating in the respective monitoring target servers as its item. Specifically, the “operating application” of the comparison information illustrated in FIG. 196 is APP-0 (V.5), APP-1 (V2), and APP-3 (V.11). The first benchmark server 31 compares the respective monitoring target servers based on the comparison information of FIG. 198, for example, and detects an abnormal event relating to the operation of an application. Specifically, for example, when the information (for example, the number of operating applications) of the “operating application” of a certain monitoring target server is different from the “operating application” of the other monitoring target servers, the first benchmark server 31 detects that an abnormal event has occurred in the monitoring target server.

Further, the comparison information illustrated in FIG. 19C has an “occurrence time” which is the time when an abnormal event occurred in the respective monitoring target servers and an “error content” which is the content of the occurred abnormal event as its items. Specifically, the comparison information illustrated in FIG. 19C has an “occurrence time” of 2013.11.12 (yyyy.mm.dd) 1333:45 (hh:mm:ss) and an “error content” indicating that the CPU usage rate has exceeded a threshold. Moreover, the comparison information illustrated in FIG. 19C has an “occurrence time” of 2013.11.12 13:33:49 and an “error content” indicating that the application APP-1 has stopped. The first benchmark server 31 analyzes the contents of the comparison information of FIG. 19C, for example, and detects an abnormal event in the monitoring target server.

Subsequently, the first benchmark server 31 compares the monitoring target servers based on the comparison information, for example, and then, aggregates information on the detected abnormal event.

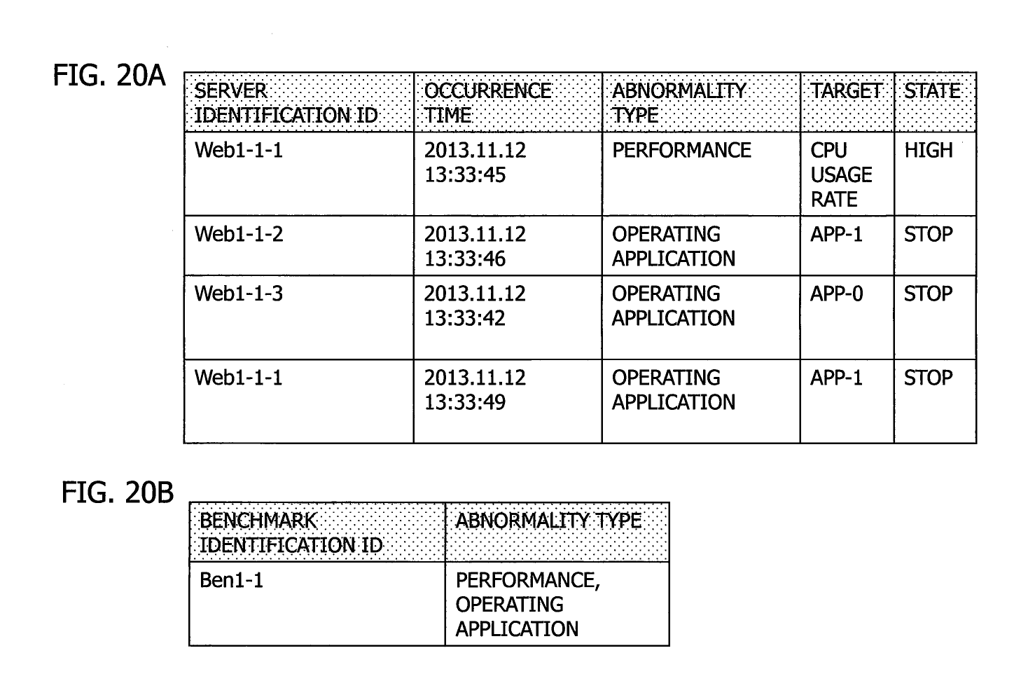

FIGS. 20A and 20B are diagrams for describing a specific example of aggregate information. FIG. 20A illustrates a specific example of aggregate information obtained by aggregating the comparison result based on the comparison information. The aggregate information illustrated in FIG. 20A has a “server identification ID” for identifying a monitoring target server; an “occurrence time” which is the occurrence time of an abnormal event, and an “abnormality type” which is the type of an occurred abnormal event as its items. Moreover, the aggregate information illustrated in FIG. 20A has a “target” which is the type of a target in which an abnormal event has occurred and a “state” indicating the state of a target in which an abnormal event has occurred as its items. Specifically, the aggregate information of FIG. 20A has a “server identification ID” of Web1-1-1, an “occurrence time” of 2013.11.12 13:33:45, an “abnormality type” of performance, a “target” of CPU usage rate, and a “state” of high. Description of the other information included in the aggregate information of FIG. 20A will not be provided. The first benchmark server 31 may arrange the aggregate information illustrated in FIG. 20A at a position that can be accessed from the management server 1, for example. By doing so, the management server 1 can acquire the aggregate information illustrated in FIG. 20A as will be described later.

Further, the first benchmark server 31 may transmit to the management server 1 the information on an abnormal event occurred after creating the aggregate information illustrated in FIG. 20A, for example. FIG. 20B illustrates a specific example of the information transmitted to the management server 1. The transmission information illustrated in FIG. 20B has a “benchmark identification ID” which is the identification information of a benchmark server that performs operational management of a server in which an abnormal event has occurred and an “abnormality type” which is the type of the occurred abnormal event as its items. Specifically, the transmission information illustrated in FIG. 20B has a “benchmark identification ID” of Ben1-1 indicating the first benchmark server 31 and an “abnormality type” of performance and an operating application. Upon receiving the transmission information illustrated in FIG. 20B, the management server 1 refers to the “benchmark identification ID” included in the transmission information and accesses the first benchmark server 31 which is the benchmark server indicated by the “benchmark identification ID.” In this way, the management server 1 can acquire the aggregate information illustrated in FIG. 20A. Moreover, the management server 1 notifies the operation administrator of the content of the occurred abnormal event based on the acquired aggregate information, for example. Hereinafter, the management of the monitoring target servers by the first benchmark server 31 will be described.

[Management of Monitoring Target Server by Benchmark Server]

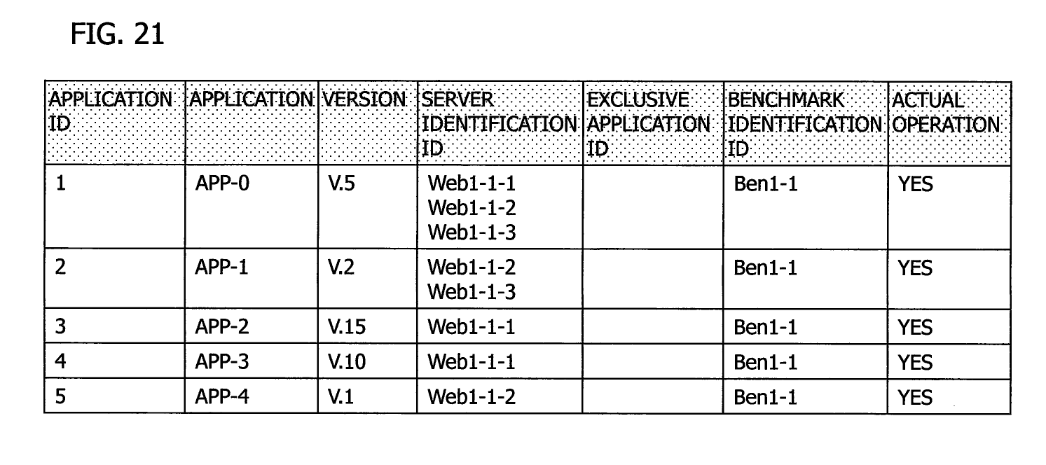

FIG. 21 is a diagram for describing a specific example of monitoring target information. Specifically, FIG. 21 illustrates a specific example of the monitoring target information 231 on the monitoring target servers that the first benchmark server 31 illustrated in FIG. 17 monitors. The first benchmark server 31 manages information on the monitoring target servers that need to be monitored by referring to the monitoring target information 231, for example.

The monitoring target information 231 illustrated in FIG. 21 has an “application ID” for identifying an application, an “application” indicating an application name, and a “version” indicating the version of an application, for example, as its items. Moreover, the monitoring target information 231 illustrated in FIG. 21 has a “server identification ID” for identifying a server on which each application operates and an “exclusive application ID” for identifying an application ID being in an exclusive relation, for example, as its items. Further, the monitoring target information 231 illustrated in FIG. 21 has a “benchmark identification ID” for identifying a benchmark server that performs operational management of each application and an “actual operation” indicating whether each application is actually operating as its items. The monitoring target information 231 illustrated in FIG. 21 has an “application ID” of 1, an “application” of APP-0, a “version” of V.5, a “server identification ID” of Web1-1-1, Web1-1-2, and Web1-1-3, for example. Further, in this case, the “exclusive application ID” is blank, the “benchmark identification ID” is Ben1-1, and the “actual operation” is “YES” indicating that the application is operating. Description of the other information included in the monitoring target information 231 of FIG. 21 will not be provided because the information has similar contents. Hereinafter, a process (management support process) when a new application is installed in a monitoring target server will be described with reference to the flowchart of FIGS. 13 to 16.

[Flowchart of Management Support Process]

First, as illustrated in FIG. 13, the exclusiveness determining unit 213 of the first benchmark server 31 checks whether a second application that is not installed in the first benchmark server 31 is present among the applications operating in the monitoring target server (S11 and S1 of FIG. 10). When the second application that is not installed in the first benchmark server 31 is present (S11: YES), the exclusiveness determining unit 213 checks whether an application that is uninstalled from all monitoring target servers is present, for example (S12). Further, when the application that is uninstalled from all monitoring target servers is not present (S12: NO), the exclusiveness determining unit 213 checks whether it is possible to install the second application (S13 and S2 of FIG. 10). When the second application is not in the exclusive relation with the first application (S13: NO), the installing unit 214 of the first benchmark server 31 installs the second application in the first benchmark server 31 so that the second application is operated in the first benchmark server 31 (S14 and S3 of FIG. 10).

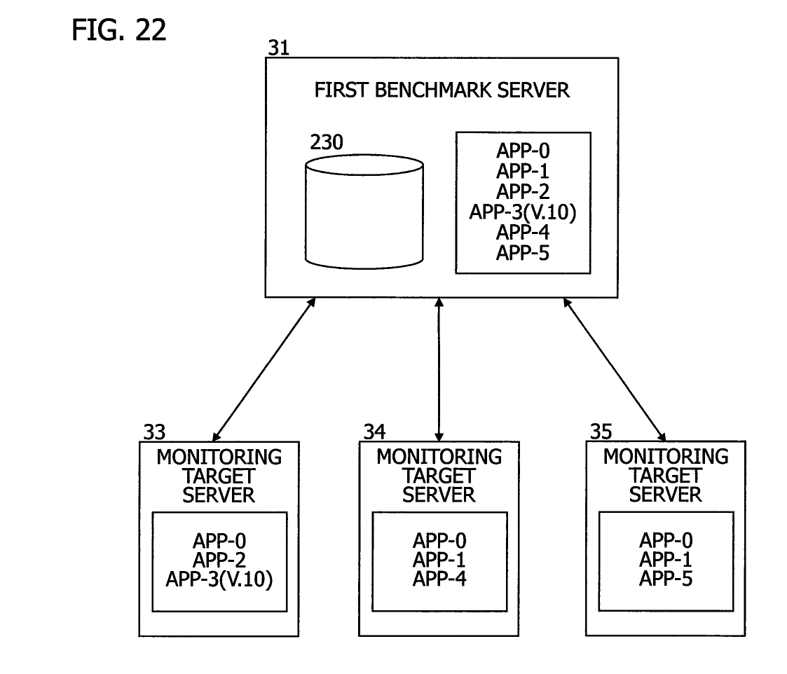

FIG. 22 is a diagram for describing a case in which a new application is installed in a monitoring target server. Specifically, in the example illustrated in FIG. 22, an application APP-5 that is not installed in the first benchmark server 31 is installed in the monitoring target server 35. In this case, the first benchmark server 31 receives information on the newly installed application APP-5 from the monitoring target server 35. Hereinafter, the information that the monitoring target server 35 transmits to the first benchmark server 31 when the application APP-5 is installed will be described.

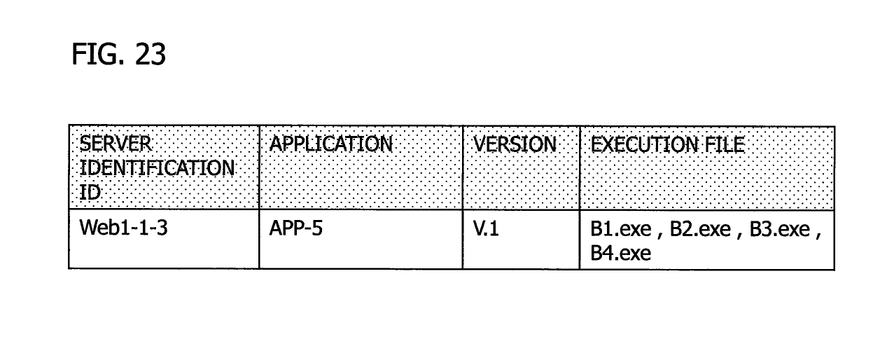

FIG. 23 is a diagram for describing a specific example of transmission information transmitted from the monitoring target server to the benchmark server. Specifically, FIG. 23 illustrates a specific example of information transmitted to the first benchmark server 31 when the application APP-5 is installed in the monitoring target server 35. The information (hereinafter also referred to as install information) illustrated in FIG. 23 has a “server identification ID” for identifying a monitoring target server that transmitted the information, an “application” indicating the installed application, and a “version” indicating the version of the installed application as its items. Moreover, the install information has an “execution file” indicating the execution file included in the installed application as its item. Specifically, the install information illustrated in FIG. 23 has a “server identification ID” of Web1-1-3, an “application” of APP-5, a “version” of V.1, and an “execution file” of B1.exe, B2.exe, B3.exe, and B4.exe. The first benchmark server 31 may store the received install information in the information storage area 230 when the install information is received, for example.

After the install information illustrated in FIG. 23 is received, the first benchmark server 31 checks whether the application APP-5 is in the exclusive relation with the applications that are already installed in the first benchmark server 31 (S13). In this case, the first benchmark server 31 may determine the presence of the exclusive relation by referring to the stored information (not illustrated) on whether the exclusive relation is present between the respective applications, for example. Moreover, for example, when a new application is installed but the installing fails, the first benchmark server 31 may determine that the exclusive relation is present between a new application and other applications. When it is determined that the application APP-5 is not in the exclusive relation with other applications (S13: NO), the first benchmark server 31 installs the application APP-5 in the first benchmark server 31 as illustrated in FIG. 22 (S14).

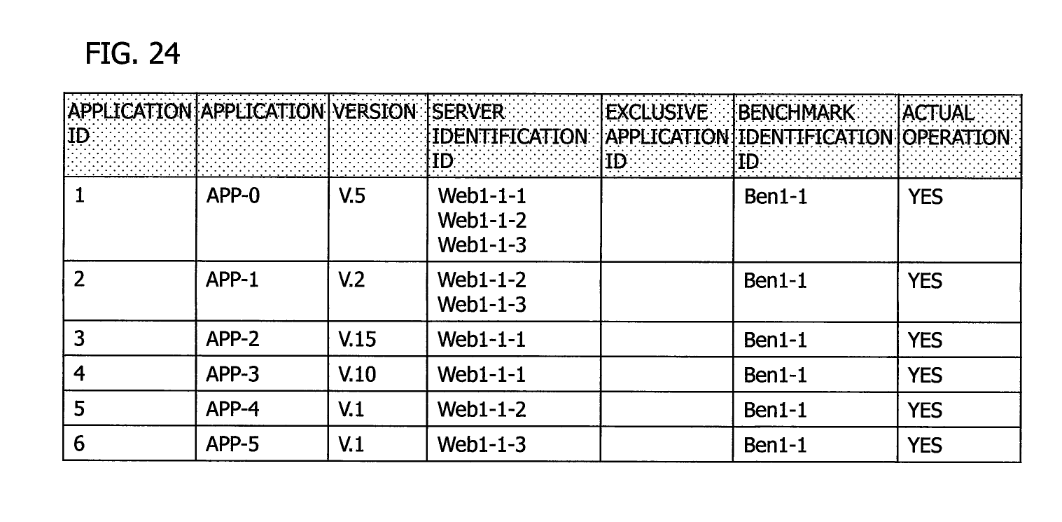

Further, in this case, the first benchmark server 31 updates the monitoring target information 231. FIG. 24 is a diagram for describing a specific example of the monitoring target information. Specifically, as illustrated in FIG. 24, information (information of which the “application ID” of 6) on the newly installed application APP-5 is added to the monitoring target information 231 illustrated in FIG. 21.

Returning to FIG. 13, when it is determined that the second application is in the exclusive relation with the first application (S13: YES), the operation testing unit 215 of the first benchmark server 31 causes the second application to be operated in the second benchmark server 38, for example (S15 and S4 of FIG. 10). The second benchmark server 38 is used for comparing the operating state in the second benchmark server 38 with the operating state in the first benchmark server 31. Due to this, the second benchmark server 38 is preferably created based on the same template as the first benchmark server 31, for example. Moreover, when the application newly installed in the monitoring target server is an application being in the exclusive relation, for example, the first benchmark server 31 may create a new second benchmark server 38. Hereinafter, a specific example of a case in which the second benchmark server 38 operates an application will be described.

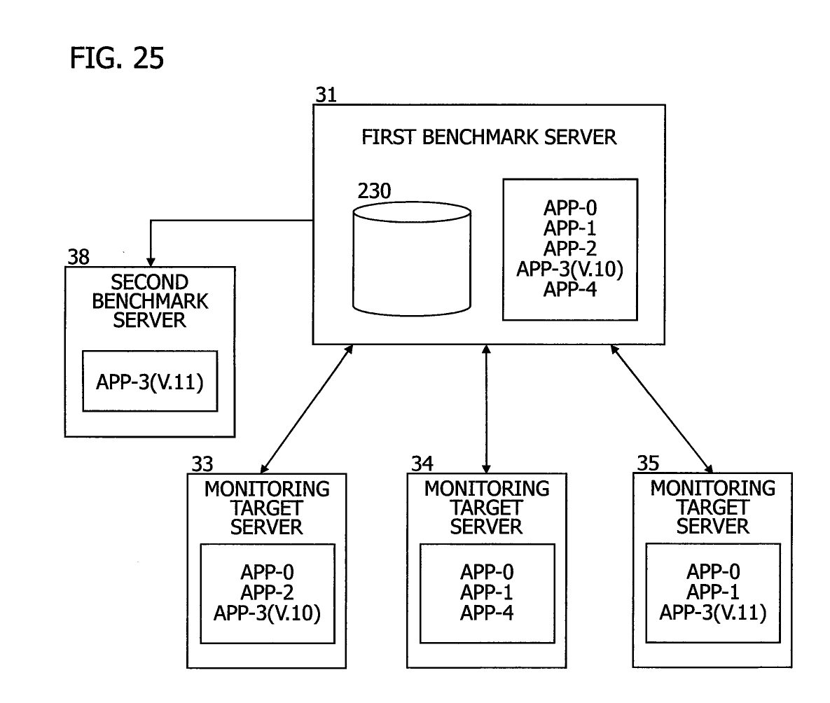

FIG. 25 is a diagram for describing a case in which a benchmark server operates an application. In FIG. 25, the monitoring target server 35 installs an application APP-3 (V.11) which is a new application. In the example illustrated in FIG. 25, the exclusiveness determining unit 213 determines whether the application APP-3 (V.11) is in the exclusive relation with the application APP-3 (V.10) installed in the first benchmark server 31 based on the install information received from the monitoring target server 35 (S13). As a result, when the exclusiveness determining unit 213 determines that the applications are in the exclusive relation (S13: YES), the operation testing unit 215 transmits the install information on the application APP-3 (V.11) received from the monitoring target server 35 to the second benchmark server 38. As illustrated in FIG. 25, the second benchmark server 38 installs the application APP-3 (V.11) and starts operating based on the received install information (S15).

Returning to FIG. 13, the operation testing unit 215 acquires the operating state of the first application operating in the first benchmark server 31 and the operating state of the second application operating in the second benchmark server 38, for example (S16). The operating state of the application is the operating state of an execution file, which is executed in association with execution of the application, of which the execution ends in association with ending of execution of the application, for example. That is, in this case, the operating state of the application is the operating state of an execution file of which the process resides in a memory during execution of the respective applications. Hereinafter, a specific example of the operating state of the execution file acquired by the operation testing unit 215 will be described.

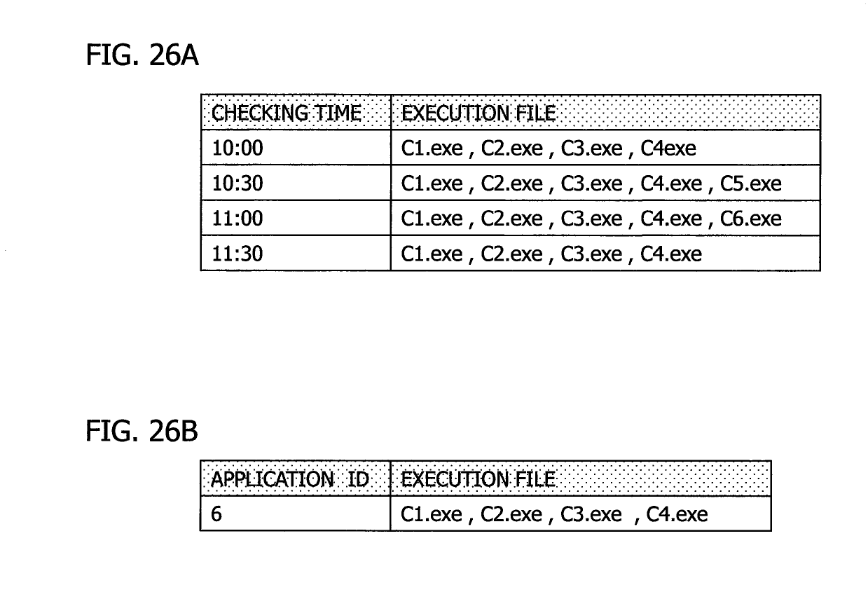

FIGS. 26A and 26B are diagrams for describing a specific example of the information on the execution file that is operating in the benchmark server. FIG. 26A illustrates a specific example of the information on the execution file that is operating in the second benchmark server 38. The information illustrated in FIG. 26A has a “checking time” which is the time at which the information on the execution file that is operating in the second benchmark server 38 is acquired and an “execution file” indicating the execution file that was operating when the information was acquired as its items. The information illustrated in FIG. 26A indicates that the “execution file” operating at 10:00 (hh:mm), for example, is C1.exe, C2.exe, C3.exe, and C4.exe. Description of other information included in the information illustrated in FIG. 26A will not be provided. That is, the second benchmark server 38 acquires information on the operating execution file every predetermined time interval (every 30 minutes in the example of FIGS. 26A and 26B), for example. By doing so, the second benchmark server 38 can acquire the information on the execution file that constantly operates in the second benchmark server 38. Specifically, in the example of FIG. 26A, the execution file that constantly operates in the second benchmark server 38 is execution files C1.exe, C2.exe, C3.exe, and C4.exe.

The second benchmark server 38 creates the information illustrated in FIG. 26B based on the information of FIG. 26A and transmits the information to the first benchmark server 31, for example. The information of FIG. 26B has an “application ID” for identifying an application and an “execution file” which is the execution file that is operating constantly as its items. Specifically, the information illustrated in FIG. 26B is information on an application of which the “application ID” is 6 and has information of execution files C1.exe, C2.exe, C3.exe, and C4.exe as the information on the execution files that are operating constantly. Due to this, the second benchmark server 38 can transmit information on the constantly operating execution file among the execution files included in the second application to the first benchmark server 31.

Moreover, the first benchmark server 31 acquires information on the constantly operating execution file of the application APP-3 (V.10) which is a comparison target of the application APP-3 (V.11) similarly to the second benchmark server 38. Description of acquisition of the operating state of the application APP-3 (V.10) will not be provided because the operating state is acquired in the same manner as the case illustrated in FIGS. 26A and 26B. Hereinafter, it is assumed that the constantly operating execution files among the execution files included in the application APP-3 (V.10) are execution files C1.exe and C5.exe.

Returning to FIG. 13, the aggregation determining unit 216 of the first benchmark server 31 calculates a degree of difference in the constantly operating execution files based on a comparison result between the operating state of the first application and the operating state of the second application, for example (S17). The degree of difference of the execution file may be the proportion of an execution file that is not included in the execution files executed in association with execution of the first application among the execution files executed in association with execution of the second application, for example. Specifically, in the example of FIGS. 26A and 26B, for example, the execution files that are operating constantly in association with execution of the second application are the four files of execution files C1.exe, C2.exe, C3.exe, and C4.exe. In contrast, the execution files that are operating constantly in association with execution of the first application are the two files of execution files C1.exe and C5.exe. That is, in this case, the execution files that are not included in the execution files executed in association with execution of the first application among the execution files executed in association with execution of the second application are the three files of execution files C2.exe, C3.exe, and C4.exe. Thus, in the example of FIGS. 26A and 26B, the degree of difference is 0.75.

Subsequently, the aggregation determining unit 216 presents a determination result as to whether the second benchmark server 38 is to be operated continuously based on the calculated degree of difference, for example (S18). Specifically, for example, when the calculated degree of difference is higher than a first threshold (for example, 0.4), the aggregation determining unit 216 may determine that the second application is to be operated continuously in the second benchmark server 38 (the second benchmark server 38 is to be operated continuously). Moreover, for example, when the calculated degree of difference is lower than the predetermined threshold, the aggregation determining unit 216 may determine that the second application is not to be operated continuously in the second benchmark server 38 (the second benchmark server 38 is not to be operated continuously). When it is determined that the second benchmark server 38 is not to be operated continuously, the first benchmark server 31 performs operational management of the first and second applications as will be described later. Hereinafter, causing the second application to be operated continuously in the second benchmark server 38 is also referred to as distributed monitoring, and causing the first benchmark server 31 to perform operational management of the first and second applications is also referred to as centralized monitoring. Hereinafter, a specific example of the determination result (the determination result presented to the user) as to whether the second benchmark server 38 is to be operated continuously will be described.

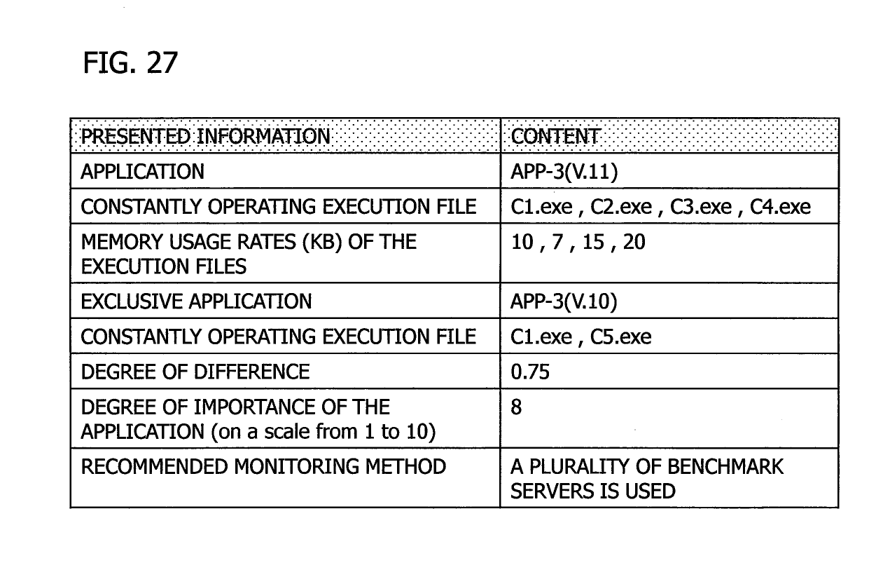

FIG. 27 is a diagram for describing a specific example of the determination result presented to the user. As illustrated in FIG. 27, the information output by the aggregation determining unit 216 includes a determination target application, a constantly operating execution file of the application, and a memory usage of each execution file, for example. Moreover, the information output by the aggregation determining unit 216 illustrated in FIG. 27 includes an application name of an application being in the exclusive relation with the determination target application, an execution file name of a constantly operating execution file of the application, the degree of difference calculated in S17, and the degree of importance of the determination target application, for example. Further, the information output by the aggregation determining unit 216 illustrated in FIG. 27 includes a recommended monitoring method which is the determination result determined by the aggregation determining unit 216 in S18. In the determination result illustrated in FIG. 27, the application is APP-3 (V.11), and the constantly operating execution files of the application APP-3 (V.11) are the execution files C1.exe, C2.exe, C3.exe, and C4.exe. Moreover, in the determination result illustrated in FIG. 27, the memory usages (KB) of the execution files are 10, 7, 15, and 20 and the exclusive application of the application APP-3 (V.11) is APP-3 (V.10). Further, in the determination result illustrated in FIG. 27, the constantly operating execution files of the application APP-3 (V.10) are execution files C1.exe and C5.exe, the degree of difference is 0.75, and the degree of importance of the application is 8. Moreover, in the determination result illustrated in FIG. 27, the recommended monitoring method is distributed monitoring in which a plurality of benchmark servers is used. The degree of importance of the application may be determined based on the information determined when the user makes a contract or the like. For example, the user may select distributed monitoring based on the information on the degree of importance of the application only for applications having a high degree of importance by referring to the information illustrated in FIG. 27. Moreover, the user may select centralized monitoring when the degree of importance of the application is low even when the degree of importance calculated in S17 is high.

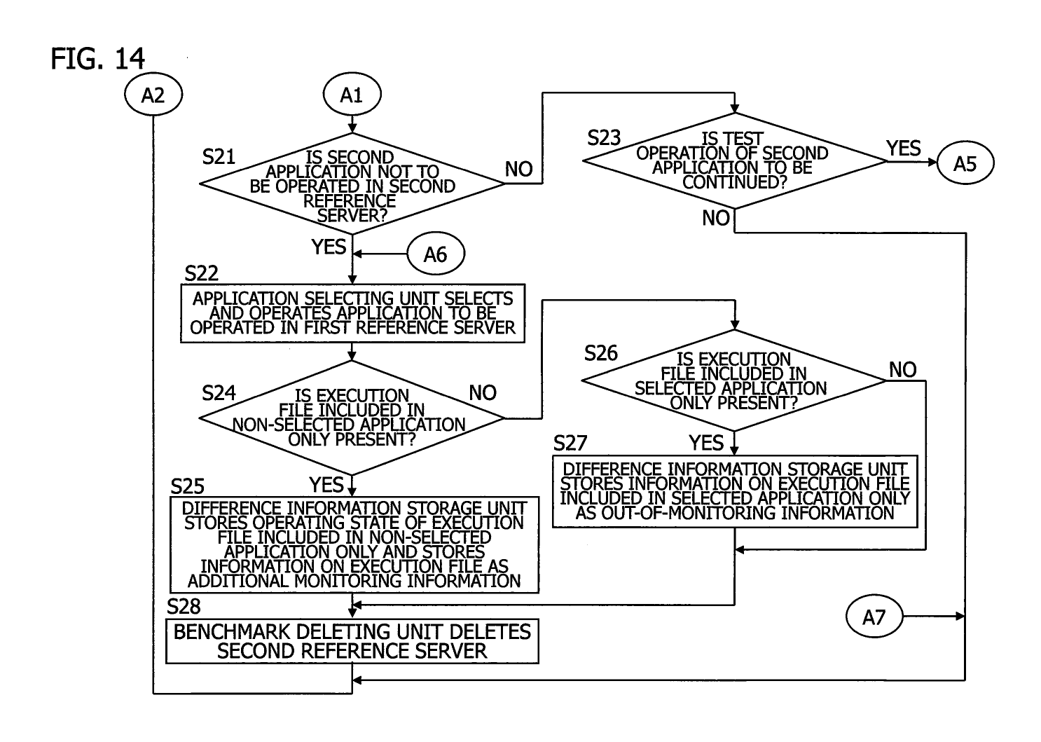

Returning to FIG. 14, for example, when the user determines that centralized monitoring is to be performed (S21: YES), the application selecting unit 217 of the first benchmark server 31 selects an application to be operated in the first benchmark server 31 and causes the application to be operated, for example (S22). That is, the application selecting unit 217 selects an application to be operated in the first benchmark server 31 among the first and second applications. Specifically, the application selecting unit 217 may select the first application which is the application installed already in the first benchmark server 31 as an application to be operated in the first benchmark server 31, for example. Moreover, the application selecting unit 217 may compare the number of monitoring target servers in which the first application operates and the number of monitoring target servers in which the second application operates and may select an application that is operated in a larger number of monitoring target servers, for example. Further, the application selecting unit 217 compares the number of execution files of which the operating state is stored by the difference information storage unit 218 described later when the first application is selected and the number of execution files of which the operating state is stored when the second application is selected. The application selecting unit 217 may select an application of which the number of execution files of which the operating state needs to be stored is smaller, for example.

That is, when the first and second applications are monitored in a centralized manner, the first benchmark server 31 needs to monitor both the first and second applications. However, since these applications are in the exclusive relation, the first benchmark server 31 is not able to install and monitor both applications. Thus, the first benchmark server 31 of the present embodiment performs monitoring by installing and operating only the selected application among the first and second applications. The selected application is monitored by comparing the operating state of the selected application operating in the first benchmark server 31 with the operating state of the selected application operating in the monitoring target server. On the other hand, the non-selected application is not installed in the first benchmark server 31. The non-selected application is monitored by comparing the operating state of the selected application and the operating state acquired in S16 with the operating state of the non-selected application operating in the monitoring target server.

That is, an execution file included in the selected application among the non-selected applications is monitored based on the present operating state of the selected application. Moreover, an execution file that is not included in the selected application among the non-selected application is monitored based on the operating state when the execution file was operated in the past. In this way, the first benchmark server 31 can monitor the first and second applications.

Subsequently, the difference information storage unit 218 of the first benchmark server 31 checks whether an execution file that is included in the non-selected application only is present, for example (S24). When the execution file that is included in the non-selected application only is present (S24: YES), the difference information storage unit 218 stores the operating state of the execution file that is included in the non-selected application only, for example (S25). Specifically, the difference information storage unit 218 may store the operating state of the execution file among the operating states of the applications acquired in S16, for example. In this way, the first benchmark server 31 can perform monitoring without installing the non-selected application.

Moreover, when the execution file that is included in the non-selected application only is present (S24: YES), the difference information storage unit 218 stores information on the execution file included in the non-selected application only as the additional monitoring information 232, for example (S25). The additional monitoring information 232 is information on an execution file of which the operating state information 234 stored in the information storage area 230 needs to be referred to when a certain application is monitored. Hereinafter, a specific example of the additional monitoring information 232 will be described.

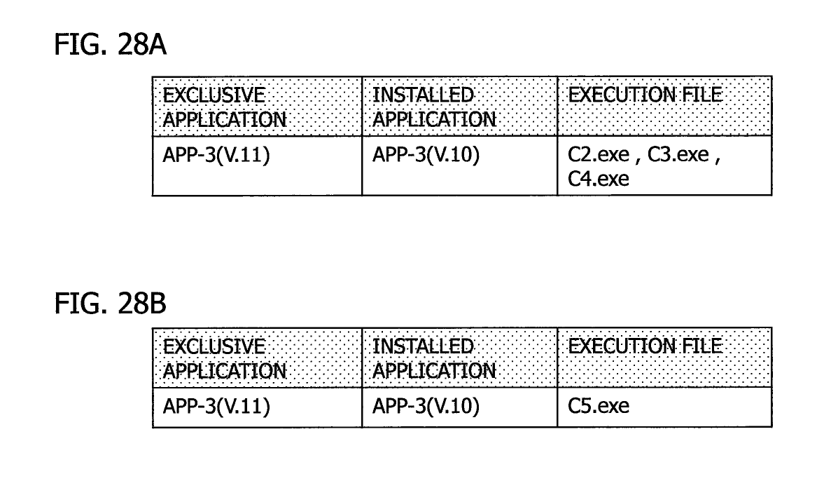

FIGS. 28A and 28B are diagrams for describing a specific example of additional monitoring information and out-of-monitoring information. FIG. 28A illustrates a specific example of the additional monitoring information 232. The additional monitoring information 232 illustrated in FIG. 28A has an “exclusive application” indicating an application that is in the exclusive relation with the application installed in the first benchmark server 31 as its item. Moreover, the additional monitoring information 232 illustrated in FIG. 28A has an “installed application” indicating the application installed in the first benchmark server 31 as its item. Further, the additional monitoring information 232 illustrated in FIG. 28A has, as its item, an “execution file” indicating the execution file of which the operating state information 234 needs to be referred to when monitoring the exclusive application. Specifically, the additional monitoring information 233 illustrated in FIG. 28A has an “exclusive application” of APP-3 (V.11), an “installed application” of APP-3 (V.10), and an “execution file” of C2.exe, C3.exe, and C4.exe. Hereinafter, it is assumed that, as described in FIGS. 26A and 26B, the execution files that are operating constantly in association with execution of the first application (application APP-3 (V.10)) are the two files of C1.exe and C5.exe. Moreover, it is assumed that, as described in FIGS. 26A and 26B, the execution files that are operating constantly in association with execution of the second application (application APP-3 (V.11)) are the four files of C1.exe, C2.exe, C3.exe, and C4.exe. Further, it is assumed that the application selecting unit 217 selects the first application as the application to be operated in the first benchmark server 31.

Specifically, three files C2.exe, C3.exe, and C4.exe which are the execution files that are included in the application APP-3 (V.11) but are not included in the application APP-3 (V.10) are stored in the additional monitoring information 232 illustrated in FIG. 28A. When monitoring the non-installed application APP-3 (V.11), the first benchmark server 31 acquires the operating state of the execution file that is needed, from the operating state information 234 and monitors the operating state by referring to the additional monitoring information 232 illustrated in FIG. 28B. That is, the first benchmark server 31 monitors the execution files C2.exe, C3.exe, and C4.exe based on the operating state information 234. In this way, when monitoring the application APP-3 (V.11), the first benchmark server 31 can monitor the execution file that is not included in the application APP-3 (V.10).

Returning to FIG. 14, when the execution file that is included in the non-selected application only is not present (S24: NO), the difference information storage unit 218 checks whether an execution file that is included in the selected application only is present, for example (S26). When the execution file included in the selected application only is present (S26: YES), the difference information storage unit 218 stores information on the execution file included in the selected application only as the out-of-monitoring information 233, for example (S27). The out-of-monitoring information 233 is information on an execution file that does not need to be monitored when a certain application is monitored. Hereinafter, a specific example of the out-of-monitoring information 233 will be described.

FIG. 28B is a specific example of the out-of-monitoring information 233. The out-of-monitoring information 233 illustrated in FIG. 28B has an “exclusive application” indicating an application that is in the exclusive relation with the application installed in the first benchmark server 31 as its item. Moreover, the out-of-monitoring information 233 illustrated in FIG. 28B has an “installed application” indicating the application installed in the first benchmark server 31 as its item. Further, the out-of-monitoring information 233 illustrated in FIG. 28B has an “execution file” indicating an execution file that does not need to be monitored when the exclusive application is monitored as its item.

Specifically, information on an execution file C5.exe which is the execution file that is included in the application APP-3 (V.10) but is not included in the application APP-3 (V.11) is stored in the out-of-monitoring information 233 illustrated in FIG. 28B. Due to this, when monitoring the application APP-3 (V.11), the first benchmark server 31 can exclude C5.exe from the execution files to be monitored by referring to the out-of-monitoring information 233 illustrated in FIG. 28B. In this way, the first benchmark server 31 can monitor applications efficiently.

Further, when it is determined that the second benchmark server 38 is to be operated continuously (S21), the first benchmark server 31 updates the monitoring target information 231.

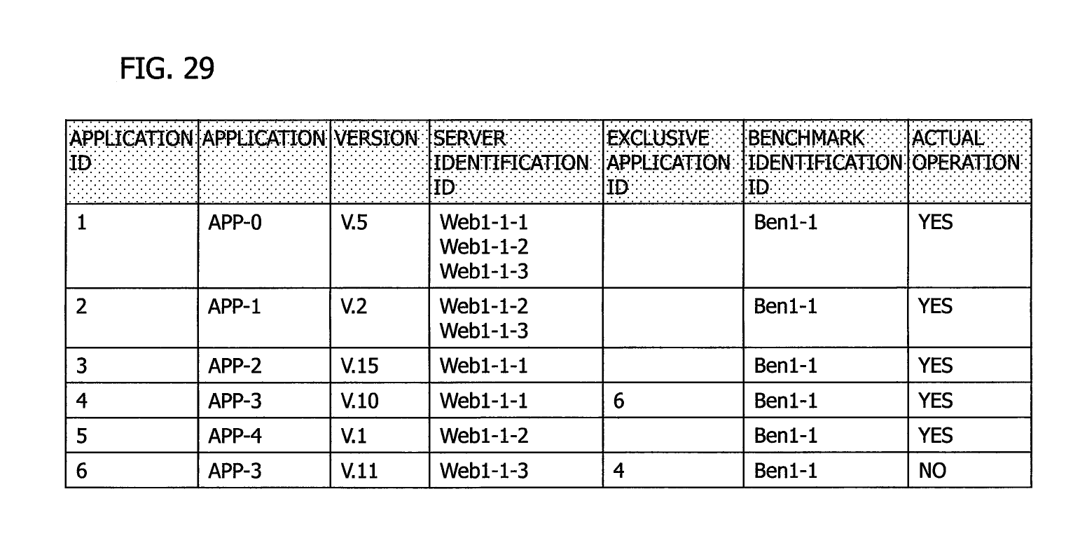

FIG. 29 is a diagram for describing a specific example of monitoring target information. FIG. 29 illustrates a specific example of the monitoring target information 231 when centralized monitoring is selected and the application APP-3 (V.10) is operated continuously in the first benchmark server 31 (S21: YES and S22). As illustrated in FIG. 29, the application selecting unit 217 stores the information (information of which the “application ID” is 6) of the newly installed application APP-3 (V.11) to the monitoring target information 231 illustrated in FIG. 21. Specifically, in the example of FIG. 29, since the first benchmark server 31 monitors the application APP-3 (V.11) by referring to the information stored in the operating state information 234, “NO” is stored in the “actual operation” item. Moreover, since the applications APP-3 (V.10) and APP-3 (V.11) are in the exclusive relation, the mutual application IDs are stored in the respective “exclusive application ID” items in the example of FIG. 29.

Returning to FIG. 14, a case in which the user determines that distributed monitoring is to be performed (S21: NO) will be described. When the user determines that distributed monitoring is to be performed, the aggregation determining unit 216 presents a determination result as to whether or not to continue a test operation for determining whether the second benchmark server 38 is to be operated continuously, for example (S23). The user determines whether or not to continue a test operation for determining whether the second benchmark server 38 is to be operated continuously based on the determination result as to whether the test operation is to be continued, for example. When the calculated degree of difference is lower than a predetermined first threshold (for example, 0.4) but is higher than a predetermined second threshold (for example, 0.2), for example, the aggregation determining unit 216 may present a determination result that the test operation of the second application is to be continued. On the other hand, when the calculated degree of difference is lower than the second threshold, for example, the aggregation determining unit 216 may present a determination result that the second application is to be operated continuously in the second benchmark server 38. In the determination result presenting step of S18, for example, the first benchmark server 31 may present the user with the determination result in such a form of presenting options including performing centralized monitoring, performing distributed monitoring with the test operation continued, and performing distributed monitoring with the test operation stopped. In this case, the user can make determination on the determination result only once. Moreover, the first benchmark server 31 may determine whether or not to continue the test operation based on the determination in S18, for example.

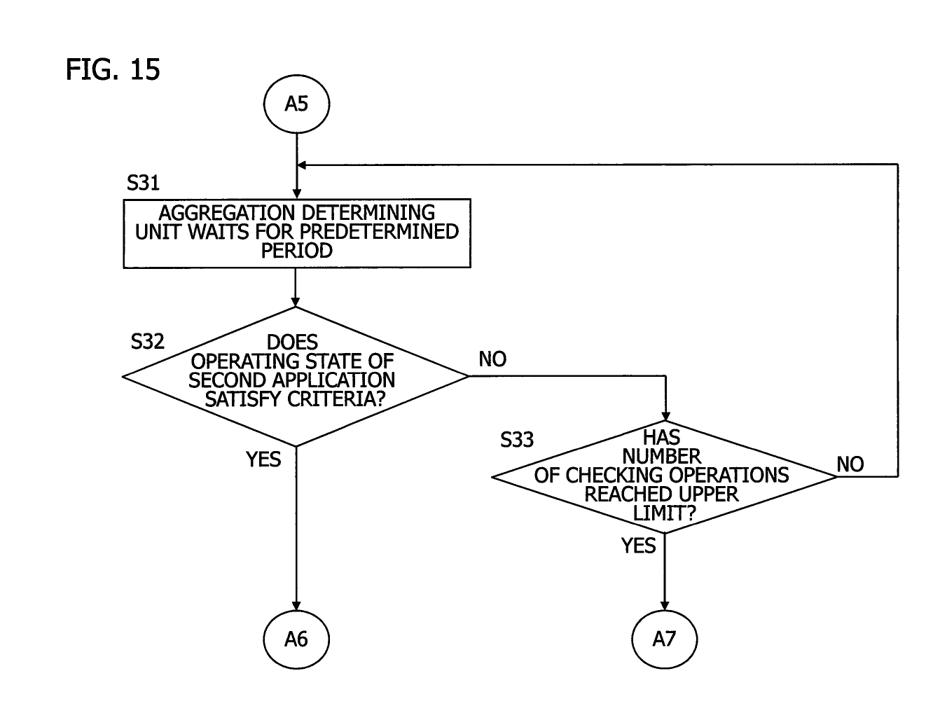

For example, when the user determines that the test operation of the second application is to be continued (S23: YES), the aggregation determining unit 216 waits for a predetermined period (for example, 10 minutes), for example, as illustrated in FIG. 15 (S31). The aggregation determining unit 216 performs the process of S22 of FIG. 14 when the operating state of the second application satisfies predetermined criteria, for example (S32: YES). The predetermined criteria may be satisfied, for example, when a change per unit time in the memory usage of the second application is lower than a predetermined threshold. That is, when the user determines that the test operation of the second application is to be continued, the aggregation determining unit 216 monitors the operating state of the second application operating in the second benchmark server 38 every predetermined time interval. When the operating state of the second application satisfies predetermined criteria, the aggregation determining unit 216 stops the operation of the second benchmark server 38, for example. The user may determine whether or not to stop the operation of the second benchmark server 38 based on the operating state of the second application.

On the other hand, when the operating state of the second application does not satisfy the predetermined criteria (S32: NO) and the number of checking operations has not reached a predetermined upper limit (S33: NO), the aggregation determining unit 216 waits for a predetermined period again (S31). When the operating state of the second application does not satisfy the predetermined criteria (S32: NO) and the number of checking operations has reached the upper limit (S33: YES), the aggregation determining unit 216 may determine that the second application is to be operated continuously in the second benchmark server and may end the test operation.

Moreover, since whether the second benchmark server 38 is to be operated continuously is determined when the test operation of the second application ends, the first benchmark server 31 updates the monitoring target information 231.

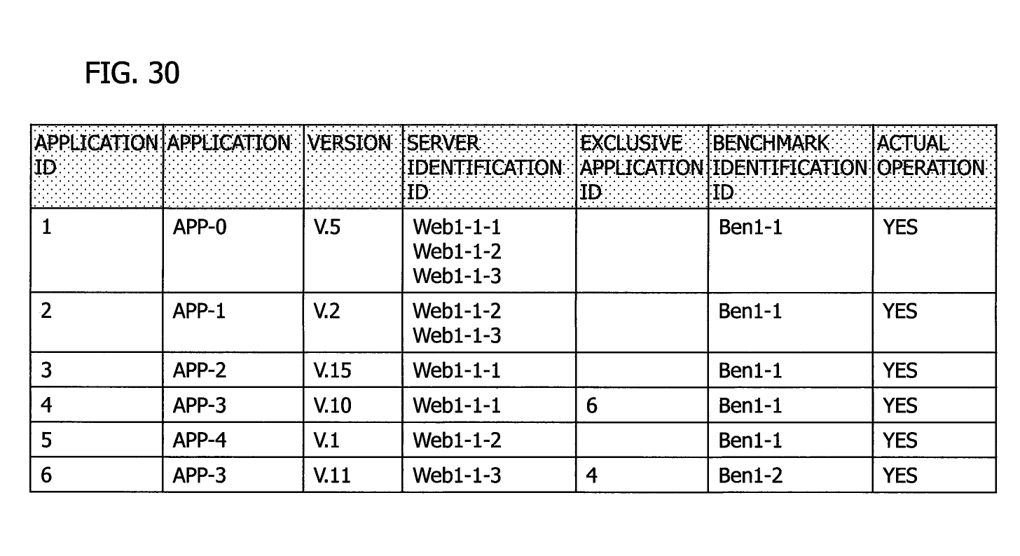

FIG. 30 is a diagram for describing a specific example of monitoring target information. FIG. 30 illustrates a specific example of the monitoring target information 231 when the first benchmark server 31 causes the application APP-3 (V.11) to be operated continuously in the second benchmark server 38. As illustrated in FIG. 30, the application selecting unit 217 stores the information (information of which the “application ID” is 6) of the newly installed application in APP-3 (V.11) to the monitoring target information 231 illustrated in FIG. 21, for example. Moreover, in the example of FIG. 30, since the application APP-3 (V.11) operates continuously in the second benchmark server 38, Ben1-2 indicating the second benchmark server 38 is stored in the “benchmark identification ID” item.

[Process when Application is Uninstalled from Benchmark Server]

Next, a process when an application (hereinafter also referred to as a deletion target application or a deletion target) uninstalled from all monitoring target servers is present will be described.

In FIG. 13, when an application uninstalled from all monitoring target servers is present (S12: YES), the uninstalling unit 220 of the first benchmark server 31 determines whether the deletion target application is to be uninstalled, for example. That is, when an application uninstalled from all monitoring target servers is present, the first benchmark server 31 does not need to operate and monitor the application. Thus, when the presence of an application uninstalled from all monitoring target servers is detected, the first benchmark server 31 uninstalls the application, for example. On the other hand, when an exclusive application of the deletion target application is present, if the application is uninstalled, the degree of difference of the exclusive application may increase. In this case, the degree of difference of the exclusive application may become higher than the first threshold that is the criteria used when determining whether the second benchmark server 38 is to be operated continuously, and it may be determined that the second benchmark server 38 needs to be prepared again. Thus, the first benchmark server 31 determines whether the deletion target application is to be uninstalled from the first benchmark server 31 in order to prevent an increase in the degree of difference of the exclusive application. Hereinafter, a process when the presence of the deletion target application is detected will be described.

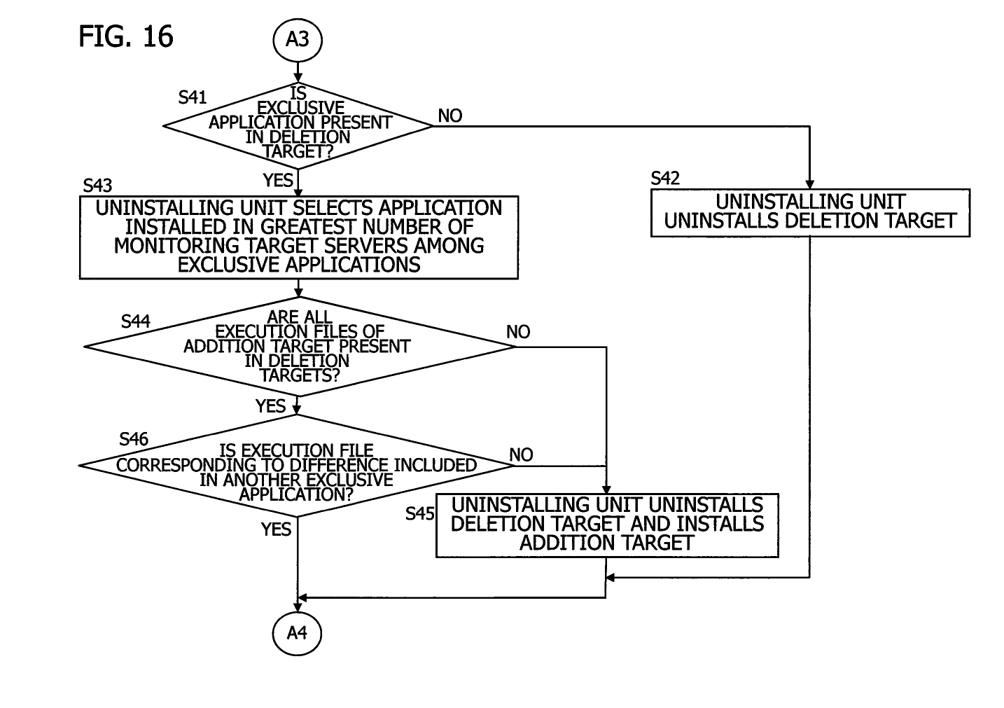

First, when the deletion target application is present (S12: YES), the uninstalling unit 220 acquires information on an exclusive application that is in the exclusive relation with the deletion target application, for example, as illustrated in FIG. 16. Specifically, the uninstalling unit 220 may acquire information on the exclusive application that is in the exclusive relation with the deletion target application by referring to the monitoring target information 231, for example. Moreover, the uninstalling unit 220 checks whether an exclusive application is present in the deletion target application, for example (S41). As a result, when the exclusive application is not present in the deletion target application (S41: NO), the uninstalling unit 220 uninstalls the deletion target application from the first benchmark server 31 and returns to the process of S11 of FIG. 13, for example (S42).

On the other hand, when the exclusive application is present in the deletion target application (S41: YES), the uninstalling unit 220 selects an application that is installed in the greatest number of monitoring target servers among the exclusive applications (S43). That is, when the deletion target application is uninstalled from the first benchmark server 31, and the exclusive application is present in the deletion target application, the first benchmark server 31 uninstalls any one of the exclusive applications. In this way, the first benchmark server 31 can increase the proportion of execution files that are actually operated and monitored by the first benchmark server 31. The application selected in S43 is also referred to as an addition target application, an addition target, or a third application. Hereinafter, a specific example of how to select an application that is installed in the greatest number of monitoring target servers will be described.

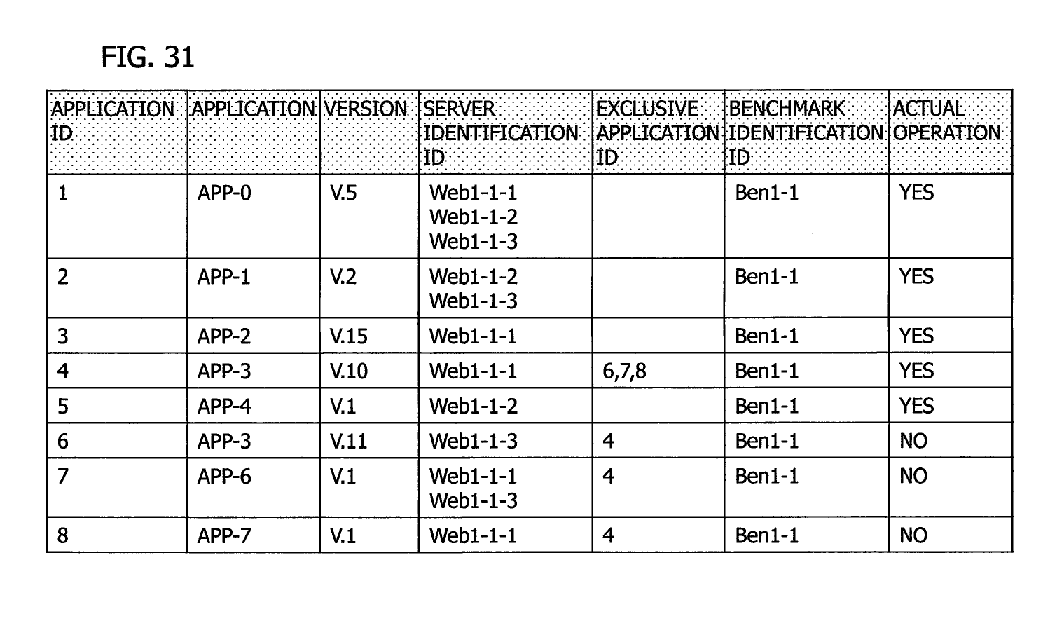

FIG. 31 is a diagram for describing a specific example of monitoring target information. Specifically, FIG. 31 illustrates an example illustrating the monitoring target information 231 indicating a state in which new applications APP-6 (V.1) and APP-7 (V.1) are installed in the monitoring target server from the state of FIG. 29. In the monitoring target information 231 illustrated in FIG. 31, information of which the application ID is 7 is information on an application APP-6 (V.1), and information of which the application ID is 8 is information on an application APP-7 (V.1). In the example illustrated in FIG. 31, a case in which an application APP-3 (V.10) installed in the first benchmark server 31 is an application that is uninstalled from all monitoring target servers.

Specifically, in the example illustrated in FIG. 31, the exclusive applications of the application APP-3 (V10) which is a deletion target application are applications of which the application IDs are 6, 7, and 8 based on the information of the exclusive application ID. That is, the exclusive applications of the application APP-3 (V.10) are applications APP-3 (V.11), APP-6 (V.1), and APP-7 (V.1). Moreover, in the example illustrated in FIG. 31, the application APP-3 (V.11) is installed in the monitoring target server Web1-1-3, and the application APP-6 (V.1) is installed in the monitoring target servers Web1-1-1 and Web1-1-3. Moreover, the application APP-7 (V.1) is installed in the monitoring target server Web1-1-1. Thus, in the example of FIG. 31, the application that is installed in the greatest number of monitoring target servers among the exclusive applications of the application APP-3 (V.10) is an application APP-6 (V.1) (S41).

Returning to FIG. 16, the uninstalling unit 220 checks whether all execution files of the addition target application are included in the execution files of the deletion target application, for example (S44). Hereinafter, an example of comparison between execution files of a deletion target application and execution files of an addition target application will be described.

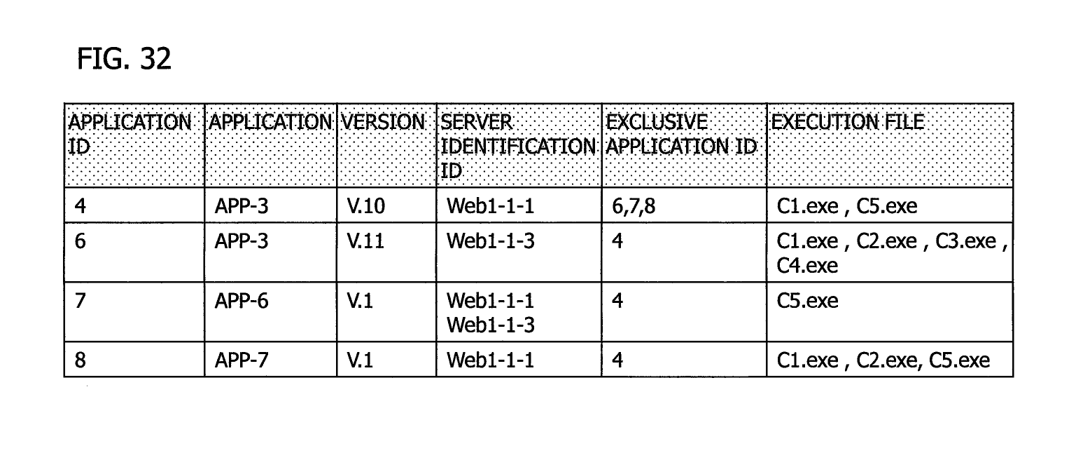

FIG. 32 is a diagram for describing correspondence between an exclusive application and an execution file. Specifically, FIG. 32 illustrates an example illustrating correspondence between an application of which the exclusive application is present among the applications illustrated in FIG. 31 and the execution files included in each application. As illustrated in FIG. 32, the execution files of an application APP-3 (V.10) which is a deletion target application are execution files C1.exe and C5.exe. Moreover, as illustrated in FIG. 32, the execution file of an application APP-6 (V.1) which is an addition target application is an execution file C5.exe. That is, in the example of FIG. 32, the execution files of the deletion target application include all execution file of the addition target application.

Returning to FIG. 16, when all execution file of the addition target application is not included in the execution files of the deletion target application (S44: NO), the uninstalling unit 220 uninstalls the deletion target application and installs the addition target application (S45). On the other hand, when all execution file of the addition target application are included (S44: YES), the uninstalling unit 220 checks whether an execution file corresponding to a difference between the deletion target application and the addition target application is included in another exclusive application (S46). When the execution file corresponding to the difference is included in another exclusive application (S46: YES), the uninstalling unit 220 does not delete the deletion target application. That is, in this case, since all execution file of the addition target application is included in the execution files of the deletion target application, the first benchmark server 31 can monitor the addition target application without installing the addition target application. Further, since the deletion target application is not uninstalled, it is possible to prevent an increase in the degree of difference of the exclusive application other than the addition target application.

Specifically, in FIG. 32, the execution files included in the application APP-7 (V.1) are execution files C1.exe, C2.exe, and C5.exe, and the execution files included in the application APP-3 (V.10) are execution files C1.exe and C5.exe. Thus, in the case of FIG. 32, the degree of difference of the application APP-7 (V.1) is 0.33 when rounded off to two decimal places. On the other hand, the execution files included in the application APP-3 (V.11) are execution files C1.exe, C2.exe, C3.exe, and C4.exe. Thus, when the application APP-3 (V.10) is uninstalled and the application APP-3 (V.11) is installed, the degree of difference of the application APP-7 (V.1) increases to 0.5. This degree of difference exceeds the first threshold described in FIG. 10 and the like. Thus, in the example illustrated in FIG. 32, the uninstalling unit 220 does not uninstall the application APP-3 (V.10).

When the execution file corresponding to the difference between the deletion target application and the selected application is not included in another exclusive application (S46: NO), the uninstalling unit 220 uninstalls the deletion target application similarly to the case of S44 (S45).

That is, when the deletion target application is present, the first benchmark server 31 determines whether or not to uninstall the application. When the deletion target application does not need to be uninstalled and the degree of difference of the exclusive application increases if the deletion target application is uninstalled, the first benchmark server 31 does not uninstall the application, for example. By doing so, the first benchmark server 31 can uninstall the deletion target application while suppressing an increase in the degree of difference of the exclusive application.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A management support method comprising:
causing a first reference server to run a first application that is installed in each of a plurality of managed servers;
causing a second reference to run a second application that is in an exclusive relation with the first application when the second application is present in any one of the plurality of managed servers;
presenting a judgement result whether the second reference server is to be operated continuously by comparing an operating state of the first application on the first reference server and an operating state of the second application on the second reference server;
selecting whether the first application or the second application is to be operated in the first reference server when the judgement result is that the second reference server is not to be operated continuously; and
storing information on a difference in operation between an selected application which is selected in the selecting and an non-selected applications which are not selected in the selecting in a storage.

2. The management support method according to claim 1, wherein
the information on the difference in operation is an operating state of a difference execution file which is an execution file that is not included in execution files executed in association with execution of the selected application among execution files executed in association with execution of the non-selected applications.

3. The management support method according to claim 1, wherein
the presenting includes determining whether the second reference server is to be operated continuously based on a proportion of an execution file that is not included in execution files executed in association with execution of the first application among execution files executed in association with execution of the second application.

4. The management support method according to claim 2, wherein
the selecting includes:
comparing a first execution file number which is the number of difference execution files when the first application is selected with a second execution file number which is the number of difference execution files when the second application is selected, and
selecting an application corresponding to a lower one of the first execution file number and the second execution file number as an application to be operated in the first reference server.

5. The management support method according to claim 2, further comprising:
causing the selected application not to be uninstalled from the first reference server when all execution files of a third application which is installed in the greatest number of managed servers among the non-selected applications are included in execution files of the selected application, and when an execution file that is not included in the third application among the execution files of the selected application is included in execution files of the non-selected applications other than the third application.

6. The management support method according to claim 1, further comprising:
redetermining that the operation of the second reference server is to be stopped when the operating state of the second application satisfies predetermined criteria after it is determined that the second reference server is to be operated continuously.

7. The management support method according to claim 6, wherein
the redetermining includes determining that the predetermined criteria are satisfied when a change per unit time in memory usage of the operation of the second application is lower than a predetermined threshold.

8. The management support method according to claim 2, further comprising:
comparing the operating state of the selected application in the first reference server with the operating state of the selected application in the plurality of managed servers to monitor the selected application in the plurality of managed servers; and
comparing the operating state of the difference execution file and the operating state of the selected application in the first reference server with the operating states of the non-selected applications in the plurality of managed servers to monitor the non-selected applications in the plurality of managed servers.

9. A management support device comprising:
a processor;
a memory storing therein a management support program that causes a computer to execute a process including,
causing a first reference server to run a first application that is installed in each of a plurality of managed servers,
causing a second reference server to run a second application that is in an exclusive relation with the first application when the second application is present in any one of the plurality of managed servers,
presenting a judgement result whether the second reference server is to be operated continuously by comparing an operating state of the first application on the first reference server and an operating state of the second application on the second reference server,
selecting whether the first application or the second application is to be operated in the first reference server when the judgement result is that the second reference server is not to be operated continuously, and
storing information on a difference in operation between a selected application which is selected in the selecting and the non-selected applications which are not selected in the selecting in a storage.

10. A non-transitory computer-readable storage medium storing therein a management support program that causes a computer to execute a process comprising:
causing a first reference server to run a first application that is installed in each of a plurality of managed servers;
causing a second reference to run a second application that is in an exclusive relation with the first application when the second application is present in any one of the plurality of managed servers;
presenting a judgement result whether the second reference server is to be operated continuously by comparing an operating state of the first application on the first reference server and an operating state of the second application on the second reference server;
selecting whether the first application or the second application is to be operated in the first reference server when the judgement result that the second reference server is not to be operated continuously; and
storing information on a difference in operation between the selected application which is selected in the selecting and a non-selected applications which are not selected in the selecting in a storage.
